(19) United States
(12) Patent Application Publication
(10) Pub. No.: US 2025/0386319 A1
(43) Pub. Date: Dec. 18, 2025

(54) COMMUNICATION-ASSISTED AUTOMATED CAMERA CALIBRATION

(71) Applicant: QUALCOMM Incorporated, San Diego, CA (US)

(72) Inventors: Kapil GULATI, Belle Mead, NJ (US); Stelios STEFANATOS, San Diego, CA (US); Shahrukh Khan KASI, San Diego, CA (US); Anantharaman BALASUBRAMANIAN, San Diego, CA (US)

(21) Appl. No.: 19/130,076

(22) PCT Filed: Dec. 11, 2023
(86) PCT No.: PCT/US2023/083362

§ 371 Date: May 14, 2025

(30) Foreign Application Priority Data
Jan. 9, 2023 (GR) 20230100012

(51) Int. Cl. H04W 64/00; H04B 17/318

(52) U.S. Cl. CPC H04W 64/00; H04B 17/328

(57) ABSTRACT

Methods, systems, and devices for wireless communications are described. Techniques described herein provide for communication-assisted automated camera calibration. An imaging device may transmit a message requesting position reports from mobile UEs satisfying a positioning condition. The UE may transmit, to the imaging device, a position report indicating a position of the UE and a visual characteristic of the UE. The imaging device may identify the UE in an image captured by the imaging device using the visual characteristic. The imaging device may determine an association between the position of the UE and a position of the UE in the captured image. The imaging device may perform the calibration procedure using the association.

### CROSS REFERENCES

The present application is a 371 national stage filing of International PCT Application No. PCT/US2023/083362 by Gulati et al. entitled “COMMUNICATION-ASSISTED AUTOMATED CAMERA CALIBRATION,” filed Dec. 11, 2023; and claims priority to Greek patent application No. 20230100012 by Gulati et al., entitled “COMMUNICATION-ASSISTED AUTOMATED CAMERA CALIBRATION,” filed Jan. 9, 2023, each of which is assigned to the assignee hereof, and each of which is expressly incorporated by reference in its entirety herein.

### FIELD OF TECHNOLOGY

The following relates to wireless communications, including communication-assisted automated camera calibration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support communication-assisted automated camera calibration. For example, the described techniques provide for calibration of an imaging device using position information reported by mobile user equipments (UEs). The mobile UE in a field of view of the imaging device may report an absolute position of the UE as well as a visual characteristic of the UE. The imaging device may identify the UE in an image captured by the imaging device using the visual characteristic. The imaging device may determine an association between the actual position of the UE and a position of the UE in the captured image. The imaging device may perform the calibration procedure using the association.

A method for wireless communications at a user equipment (UE) is described. The method may include receiving, from an imaging device, a message requesting position reports from mobile UEs that satisfy a positioning condition and transmitting, to the imaging device and based on the UE satisfying the positioning condition, a position report indicating a position of the UE and a visual characteristic of the UE.

An apparatus for wireless communications at a UE is described. The apparatus may include a processor, memory coupled with the processor, and instructions stored in the memory. The instructions may be executable by the processor to cause the apparatus to receive, from an imaging device, a message requesting position reports from mobile UEs that satisfy a positioning condition and transmit, to the imaging device and based on the UE satisfying the positioning condition, a position report indicating a position of the UE and a visual characteristic of the UE.

Another apparatus for wireless communications at a UE is described. The apparatus may include means for receiving, from an imaging device, a message requesting position reports from mobile UEs that satisfy a positioning condition and means for transmitting, to the imaging device and based on the UE satisfying the positioning condition, a position report indicating a position of the UE and a visual characteristic of the UE.

A non-transitory computer-readable medium storing code for wireless communications at a UE is described. The code may include instructions executable by a processor to receive, from an imaging device, a message requesting position reports from mobile UEs that satisfy a positioning condition and transmit, to the imaging device and based on the UE satisfying the positioning condition, a position report indicating a position of the UE and a visual characteristic of the UE.

Some examples of the method, apparatuses, and non-transitory computer-readable medium described herein may further include operations, features, means, or instructions for receiving an indication of a geographic region, where the UE satisfies the positioning condition based on the UE being located within the geographic region.

Some examples of the method, apparatuses, and non-transitory computer-readable medium described herein may further include operations, features, means, or instructions for receiving a reference signal from the imaging device and receiving an indication of a reference signal received power (RSRP) threshold, where the UE satisfies the positioning condition based on a RSRP of the reference signal satisfying the RSRP threshold.

Some examples of the method, apparatuses, and non-transitory computer-readable medium described herein may further include operations, features, means, or instructions for receiving an indication of a position of the imaging device, a heading of the imaging device, and a field of view (FOV) of the imaging device, where the UE satisfies the positioning condition based on the UE being located within the FOV of the imaging device with respect to the position of the imaging device and the heading of the imaging device.

Some examples of the method, apparatuses, and non-transitory computer-readable medium described herein may further include operations, features, means, or instructions for receiving an indication of a timing for determination of the position of the UE for inclusion within the position report.

In some examples of the method, apparatuses, and non-transitory computer-readable medium described herein, the position includes geographic coordinates of the UE.

In some examples of the method, apparatuses, and non-transitory computer-readable medium described herein, transmitting the position report may include operations, features, means, or instructions for transmitting an indication of at least one of a timestamp indicating a time the position of the UE was measured, an accuracy estimate of the position, a speed of the UE, a heading of the UE, a make and model of the UE, a color of the UE, a vehicle type of the UE, a license plate number, or a RSRP measurement responsive to the message.

In some examples of the method, apparatuses, and non-transitory computer-readable medium described herein, the visual characteristic includes at least one of the make and model of the UE, the color of the UE, the vehicle type of the UE, or the license plate number.

In some examples of the method, apparatuses, and non-transitory computer-readable medium described herein, receiving the message may include operations, features, means, or instructions for receiving an indication to transmit, with the position report, the at least one of the timestamp, the accuracy estimate, the speed of the UE, the heading of the UE, the make and model of the UE, the color of the UE, the vehicle type, the license plate number, or the RSRP measurement.

Some examples of the method, apparatuses, and non-transitory computer-readable medium described herein may further include operations, features, means, or instructions for receiving, from the imaging device, a second message indicating an estimated position of the UE and a timestamp corresponding to the estimated position and transmitting, to the imaging device, an acknowledgement (ACK) message in response to the second message based on the estimated position being within a threshold of a measured position of the UE performed by the UE at a time corresponding to the timestamp.

Some examples of the method, apparatuses, and non-transitory computer-readable medium described herein may further include operations, features, means, or instructions for receiving a message indicating an estimated position of the UE and a timestamp corresponding to the estimated position and transmitting, to the imaging device, a negative acknowledgement (NACK) message in response to the second message based on the estimated position being outside of a threshold of a measured position of the UE performed by the UE at a time corresponding to the timestamp.

Some examples of the method, apparatuses, and non-transitory computer-readable medium described herein may further include operations, features, means, or instructions for receiving a message indicating an estimated position of the UE and a timestamp corresponding to the estimated position and transmitting, to the imaging device, a NACK message in response to the second message based on the UE not having a position measurement of the UE performed by the UE at a time corresponding to the timestamp.

Some examples of the method, apparatuses, and non-transitory computer-readable medium described herein may further include operations, features, means, or instructions for receiving a message indicating an estimated position of the UE and a timestamp corresponding to the estimated position and refraining from transmitting a feedback message to the imaging device in response to the second message based on the UE not having a position measurement of the UE performed by the UE at a time corresponding to the timestamp.

In some examples of the method, apparatuses, and non-transitory computer-readable medium described herein, transmitting the position report may include operations, features, means, or instructions for transmitting a set of differential rotation matrices and differential translation vectors, each differential rotation matrix indicating a change in vehicle orientation between two respective times and each differential translation vector indicating a change in vehicle position between the two respective times.

In some examples of the method, apparatuses, and non-transitory computer-readable medium described herein, transmitting the position report may include operations, features, means, or instructions for transmitting an indication of the two respective times for each of the set of differential rotation matrices and differential translation vectors.

In some examples of the method, apparatuses, and non-transitory computer-readable medium described herein, receiving the message may include operations, features, means, or instructions for receiving an indication of times at which to generate the set of differential rotation matrices and differential translation vectors, where the two respective times for each of the set of differential rotation matrices and differential translation vectors may be based on the indication of times.

In some examples of the method, apparatuses, and non-transitory computer-readable medium described herein, receiving the message may include operations, features, means, or instructions for receiving an indication of a quantity of differential rotation matrices and differential translation vectors to report.

A method for wireless communications at an imaging device is described. The method may include transmitting a message requesting position reports from mobile user equipments (UEs) that satisfy a positioning condition and receiving, from a UE in response to the message, a position report indicating a position of the UE and a visual characteristic of the UE.

An apparatus for wireless communications at an imaging device is described. The apparatus may include a processor, memory coupled with the processor, and instructions stored in the memory. The instructions may be executable by the processor to cause the apparatus to transmit a message requesting position reports from mobile user equipments (UEs) that satisfy a positioning condition and receive, from a UE in response to the message, a position report indicating a position of the UE and a visual characteristic of the UE.

Another apparatus for wireless communications at an imaging device is described. The apparatus may include means for transmitting a message requesting position reports from mobile user equipments (UEs) that satisfy a positioning condition and means for receiving, from a UE in response to the message, a position report indicating a position of the UE and a visual characteristic of the UE.

A non-transitory computer-readable medium storing code for wireless communications at an imaging device is described. The code may include instructions executable by a processor to transmit a message requesting position reports from mobile user equipments (UEs) that satisfy a positioning condition and receive, from a UE in response to the message, a position report indicating a position of the UE and a visual characteristic of the UE.

Some examples of the method, apparatuses, and non-transitory computer-readable medium described herein may further include operations, features, means, or instructions for identifying, in an image captured by the imaging device at a time corresponding to the position report, a vehicle corresponding to the UE based on the visual characteristic, determining an association between the position of the UE and a portion of the image that includes the vehicle, and performing a camera location calibration procedure based on the association.

Some examples of the method, apparatuses, and non-transitory computer-readable medium described herein may further include operations, features, means, or instructions for transmitting an indication of a geographic region, where the mobile UEs satisfy the positioning condition based on the mobile UEs being located within the geographic region.

Some examples of the method, apparatuses, and non-transitory computer-readable medium described herein may further include operations, features, means, or instructions for transmitting a reference signal and transmitting an indication of a RSRP threshold, where the mobile UEs satisfy the positioning condition based on a RSRP of the reference signal satisfying the RSRP threshold.

Some examples of the method, apparatuses, and non-transitory computer-readable medium described herein may further include operations, features, means, or instructions for transmitting an indication of a position of the imaging device, a heading of the imaging device, and a FOV of the imaging device, where the mobile UEs satisfy the positioning condition based on the mobile UEs being located within the FOV of the imaging device with respect to the position of the imaging device and the heading of the imaging device.

Some examples of the method, apparatuses, and non-transitory computer-readable medium described herein may further include operations, features, means, or instructions for transmitting an indication of a timing for determination of the position of the mobile UEs for inclusion within the position reports.

In some examples of the method, apparatuses, and non-transitory computer-readable medium described herein, the position includes geographic coordinates of the UE.

In some examples of the method, apparatuses, and non-transitory computer-readable medium described herein, receiving the position report may include operations, features, means, or instructions for receiving an indication of at least one of a timestamp indicating a time the position of the UE was measured, an accuracy estimate of the position, a speed of the UE, a heading of the UE, a make and model of the UE, a color of the UE, a vehicle type of the UE, a license plate number, or a RSRP measurement responsive to the message.

In some examples of the method, apparatuses, and non-transitory computer-readable medium described herein, the visual characteristic includes at least one of the make and model of the UE, the color of the UE, the vehicle type of the UE, or the license plate number.

In some examples of the method, apparatuses, and non-transitory computer-readable medium described herein, transmitting the message may include operations, features, means, or instructions for transmitting an indication to transmit, with the position reports, the at least one of the timestamp, the accuracy estimate, the speed of the UE, the heading of the UE, the make and model of the UE, the color of the UE, the vehicle type, the license plate number, or the RSRP measurement.

Some examples of the method, apparatuses, and non-transitory computer-readable medium described herein may further include operations, features, means, or instructions for transmitting, to the UE in response to the position report, a second message indicating an estimated position of the UE and a timestamp corresponding to the estimated position and receiving, from the UE, an ACK message in response to the second message based on the estimated position being within a threshold of a measured position of the UE performed by the UE at a time corresponding to the timestamp.

Some examples of the method, apparatuses, and non-transitory computer-readable medium described herein may further include operations, features, means, or instructions for transmitting, to the UE in response to the position report, a second message indicating an estimated position of the UE and a timestamp corresponding to the estimated position and receiving, from the UE, a NACK message in response to the second message based on the estimated position being outside of a threshold of a measured position of the UE performed by the UE at a time corresponding to the timestamp.

Some examples of the method, apparatuses, and non-transitory computer-readable medium described herein may further include operations, features, means, or instructions for transmitting a second message indicating an estimated position of the UE and a timestamp corresponding to the estimated position and receiving, from the UE, a NACK message in response to the second message based on the UE not having a position measurement of the UE performed by the UE at a time corresponding to the timestamp.

In some examples of the method, apparatuses, and non-transitory computer-readable medium described herein, receiving the position report may include operations, features, means, or instructions for receiving a set of differential rotation matrices and differential translation vectors, each differential rotation matrix indicating a change in vehicle orientation between two respective times and each differential translation vector indicating a change in vehicle position between the two respective times.

In some examples of the method, apparatuses, and non-transitory computer-readable medium described herein, receiving the position report may include operations, features, means, or instructions for receiving an indication of the two respective times for each of the set of differential rotation matrices and differential translation vectors.

In some examples of the method, apparatuses, and non-transitory computer-readable medium described herein, transmitting the message may include operations, features, means, or instructions for transmitting an indication of times at which to generate the set of differential rotation matrices and differential translation vectors, where the two respective times for each of the set of differential rotation matrices and differential translation vectors may be based on the indication of times.

In some examples of the method, apparatuses, and non-transitory computer-readable medium described herein, transmitting the message may include operations, features, means, or instructions for an indication of a quantity of differential rotation matrices and differential translation vectors to report.

### BRIEF DESCRIPTION OF THE DRAWINGS

FIG. 1 illustrates an example of a wireless communications system that supports communication-assisted automated camera calibration in accordance with one or more aspects of the present disclosure.

FIG. 2 illustrates an example of a wireless communications system that supports communication-assisted automated camera calibration in accordance with one or more aspects of the present disclosure.

FIG. 3 illustrates an example of an imaging device calibration diagram that supports communication-assisted automated camera calibration in accordance with one or more aspects of the present disclosure.

FIG. 4 illustrates an example of a wireless communications system that supports communication-assisted automated camera calibration in accordance with one or more aspects of the present disclosure.

FIG. 5 illustrates an example of an imaging device calibration diagram that supports communication-assisted automated camera calibration in accordance with one or more aspects of the present disclosure.

FIG. 6 illustrates an example of a wireless communications system that supports communication-assisted automated camera calibration in accordance with one or more aspects of the present disclosure.

FIG. 7 illustrates an example of a process flow that supports communication-assisted automated camera calibration in accordance with one or more aspects of the present disclosure.

FIGS. 8 and 9 illustrate block diagrams of devices that support communication-assisted automated camera calibration in accordance with one or more aspects of the present disclosure.

FIG. 10 illustrates a block diagram of a communications manager that supports communication-assisted automated camera calibration in accordance with one or more aspects of the present disclosure.

FIG. 11 illustrates a diagram of a system including a device that supports communication-assisted automated camera calibration in accordance with one or more aspects of the present disclosure.

FIGS. 12 and 13 illustrate block diagrams of devices that support communication-assisted automated camera calibration in accordance with one or more aspects of the present disclosure.

FIG. 14 illustrates a block diagram of a communications manager that supports communication-assisted automated camera calibration in accordance with one or more aspects of the present disclosure.

FIG. 15 illustrates a diagram of a system including a device that supports communication-assisted automated camera calibration in accordance with one or more aspects of the present disclosure.

FIGS. 16 through 19 illustrate flowcharts showing methods that support communication-assisted automated camera calibration in accordance with one or more aspects of the present disclosure.

### DETAILED DESCRIPTION

Advanced driving assistance system (ADAS) applications may demand an accurate representation of a driving environment, including dynamic features such as location, speed, and heading of vehicles or pedestrians, locations of road obstacles or hazards, as well as traffic conditions. Imaging devices, such as still cameras or video cameras, may be mounted proximate the road network for security or other purposes. While not installed for the purpose of assisting ADAS applications, these cameras may be used to provide information to ADAS applications. Use of the roadside imaging device for ADAS assistance may demand that the imaging device be calibrated with location information. While absolute position information for the imaging device may be manually provided to the imaging device, such manual input of position information may be burdensome. One option to calibrate an imaging device may be to use known position information of an object within a field of view (FOV) of the imaging device (such as a landmark), and then determine the imaging device's relative position based on the position of the landmark in the 2D image frame. However, many imaging devices lack known landmarks, and the determination of the imaging device's position from a static landmark may be prone to error.

A roadside imaging device may use information obtained from moving vehicles that transmit vehicular information. For example, a vehicular user equipment (UE) (e.g., a mobile UE) in the FOV of the imaging device may report an absolute position of the UE as well as a visual characteristic of the UE, such that the imaging device may determine an association between the actual position of the UE and an image captured by the camera that includes the UE. The imaging device may perform a camera location calibration procedure using the association. The imaging device may perform the calibration procedure using position reports that include visual characteristics from multiple UEs in order to identify the mobile UEs in the image(s) captured by the camera.

The imaging device may transmit a message requesting mobile UEs provide position reports, for example from mobile UEs that satisfy a position condition (e.g., UEs that are within an identified geographic region, UEs that are in the FOV of the imaging device, or UEs that are deemed to be close enough to the camera based on a reference signal received power (RSRP) strength). The visual characteristic of the UE may be a make and model of a vehicle, a vehicle type, a vehicle color, or a license plate number. The position report may also provide a timestamp corresponding to a time the position of the UE was measured. The position report may also provide a set of differential rotational matrices and differential translation vectors of the UE. The differential rotational matrix may provide a change in UE orientation, and the differential translation vectors may provide a change in position, over a series of time instances. Accordingly, the imaging device may calibrate key points (e.g., vertices of the vehicle) in order to reduce errors based on, for example, an assumption that a road is flat.

Aspects of the disclosure are initially described in the context of wireless communications systems. Additional aspects for the disclosure are described in the context of wireless communication system, example imaging device calibration diagrams, example geographic region diagrams, and an example process flow. Aspects of the disclosure are further illustrated by and described with reference to apparatus diagrams, system diagrams, and flowcharts that relate to communication-assisted automated camera calibration.

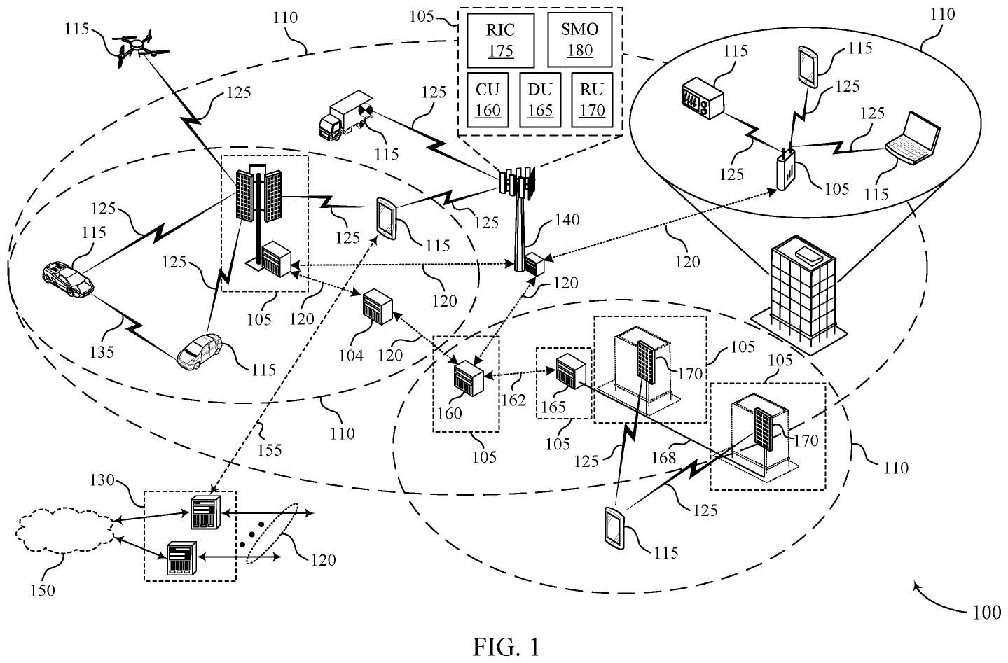

FIG. 1 illustrates an example of a wireless communications system 100 that supports communication-assisted automated camera calibration in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support communication-assisted automated camera calibration as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

ADAS applications may require an accurate representation of a driving environment, including dynamic features such as location, speed, and heading of vehicles or pedestrians, locations of road obstacles or hazards, as well as traffic conditions. Imaging devices, such as still cameras or video cameras, may be mounted proximate the road network for security or other purposes. While not installed for the purpose of assisting ADAS applications, these cameras may be used to provide information to ADAS applications. Use of the roadside imaging device for ADAS assistance may require that the imaging device be calibrated with location information. While absolute position information for the imaging device may be manually provided to the imaging device, less burdensome options are desired. One option may be to use known position information of an object within a FOV of the imaging device (such as a significant landmark), and then determine the imaging device's relative position based on the position of the landmark in the 2D image frame. However, many imaging devices lack known landmarks, and the determination of the imaging device's position from a static landmark may be prone to error.

The roadside imaging device may be considered a network entity 105. For example, the imaging device may include a transceiver for communicating with UEs 115 and other network entities 105. In some examples, the imaging device may be part of roadside infrastructure, such as a roadside unit, that may communicate in a sidelink or a V2X system with UEs 115, such as the vehicles, or with the network via one or more network nodes (e.g., network entities 105, base stations 140, RUs 170) using vehicle-to-network (V2N) communications.

A roadside imaging device may use information obtained from moving vehicles that transmit vehicular information. For example, a vehicular UE 115 in the FOV of the imaging device may report an absolute position of the UE 115 as well as a visual characteristic of the UE 115, such that the imaging device may determine an association between the actual position of the UE 115 and an image captured by the camera that includes the UE 115. The imaging device may perform a camera location calibration procedure using the association. The imaging device may perform the calibration procedure using position reports that include visual characteristics from multiple UEs 115.

The imaging device may transmit a message requesting mobile UEs 115 provide position reports, for example from vehicular UEs 115 that satisfy a position condition (e.g., UEs 115 that are within an identified geographic region, UEs 115 that are in the FOV of the imaging device, or UEs 115 that are deemed to be close enough to the camera based on a RSRP strength). The visual characteristic of the UE 115 may be a make and model of a vehicle, a vehicle type, a vehicle color, or a license plate number. The position report may also provide a timestamp corresponding to a time the position of the UE 115 was measured. The position report may also provide a set of differential rotational matrices and differential translation vectors of the UE 115. The differential rotational matrix may provide a change in UE 115 orientation, and the differential translation vectors provide a change in position. Accordingly, the imaging device may calibrate key points (e.g., vertices of the vehicle) in order to reduce errors based on, for example, an assumption that a road is flat.

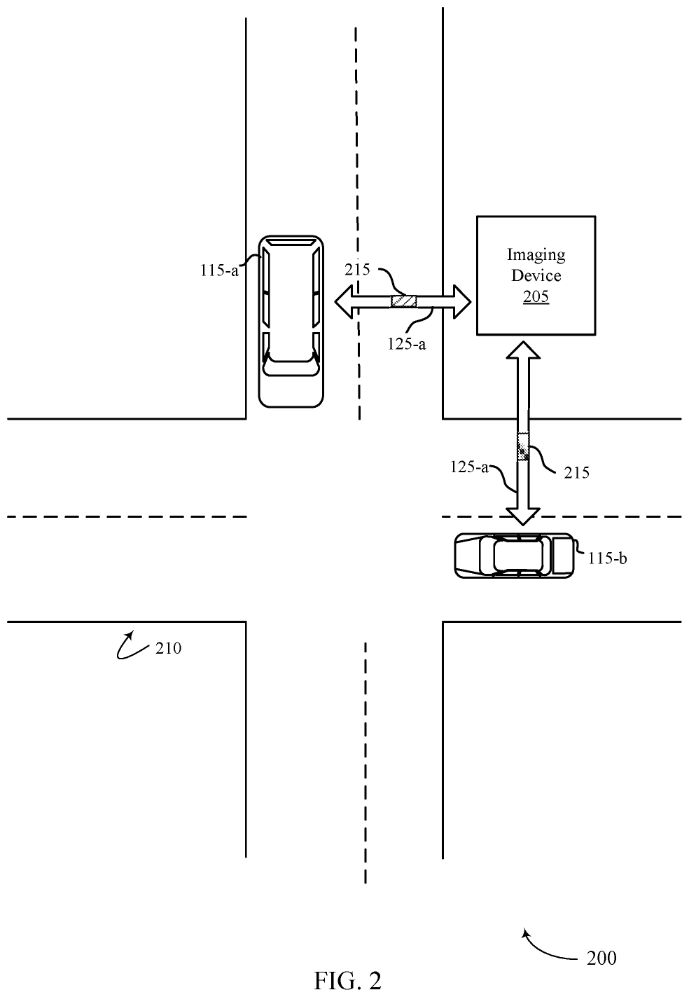

FIG. 2 illustrates an example of a wireless communications system 200 that supports communication-assisted automated camera calibration in accordance with one or more aspects of the present disclosure. In some examples, the wireless communications system 200 may implement aspects of wireless communications system 100. Wireless communications system 200 may include a network entity or imaging device 205 and a vehicle 115-a and a vehicle 115-b, which may be examples of corresponding network entities 105 and UEs 115, respectively, as described herein with reference to FIG. 1.

In some examples, the imaging device 205 may be considered a network entity, such as the network entities 105 of the wireless communications system 100. For example, the imaging device 205 may include a transceiver for communicating with UEs and other network entities. In some examples, the imaging device 205 may be part of roadside infrastructure, such as a roadside unit, that may communicate in a sidelink or a V2X system with UEs, such as the vehicle 115-a and the vehicle 115-b, or with the network via one or more network nodes (e.g., network entities 105, base stations 140, RUs 170) using V2N communications.

In some examples, the imaging device 205 may be located proximate to a road network 210. The imaging device 205 may capture images, such as periodic still images or a video, of a portion of the road network 210. For example, the imaging device 205 may capture an image with the vehicle 115-a and the vehicle 115-b on the road network 210. In some examples, the imaging device 205 may communicate with the vehicle 115-a via a communication link 125-a, and the imaging device 205 may communicate with the vehicle 115-b via the communication link 125-a. For example, the imaging device 205 may transmit messages 215 to the vehicle 115-a and the vehicle 115-b, and the imaging device 205 may receive messages 215 from the vehicle 115-a and the vehicle 115-b.

ADAS applications for vehicles may demand accurate knowledge of the driving environment, such as the road network 210. High definition maps used by ADAS applications may provide detailed information of stationary features of the road network 210, such as the positions of lanes, positions of obstacles on the road, and the positions of roadside furniture, such as lights, signs and barriers. Some ADAS applications may also demand awareness of dynamic features of the road network 210, such as the location, speed, heading of vehicles and/or pedestrians, traffic congestion and the presence of unexpected road obstacles.

While not installed for the purpose of assisting ADAS applications, the imaging device 205 may be used to provide information to ADAS applications. Many imaging devices, such as imaging device 205, may be deployed along the road network 210, such as traffic cameras, closed-circuit television (CCTV) and security cameras. The images captured from the imaging device 205 may be publicly available for evaluating the real-time environment and conditions on the road network 210. The imaging device 205 may be elevated above the road network 210 and may provide a bird's eye FOV of intersections of the road network 210. The imaging device 205 may provide useful information that may not be obtained from vehicle-mounted cameras having close-to-ground location and more limited FOV. In some examples, the imaging device 205 may be utilized for observing and learning human driving behavior in complicated and/or non-typical driving conditions or environments that current automated ADAS systems may function in an unnatural manner, for example, entering roundabouts the wrong way or a road with consecutive turns.

ADAS applications may demand position accuracy, and the imaging device 205 may be used to infer the 3D position of the vehicle 115-a or other object that appears in the image captured by the imaging device 205. The imaging device 205 may be calibrated to provide the positional accuracy for ADAS applications. However, the imaging device 205 may not be calibrated or the prior calibration may no longer be sufficiently accurate for ADAS applications. In some examples, calibration of the imaging device 205 may be sufficient for measuring relative distance, such as used for traffic speed estimations, but may provide insufficient absolute positioning accuracy of the vehicle 115-a or other objects captured in the image. In some examples, currently deployed traffic cameras may have been installed for manual (human) monitoring or surveillance applications without being calibrated.

A calibrated imaging device 205 may provide the mapping or correspondence of points in the world 3D coordinates to image pixel 2D coordinates and vice versa. When the imaging device 205 is calibrated, the position of the object in world 3D coordinates may be inferred from the position of the object in the image, and the distance between points of objects in the world may be inferred from the distance between the objects in the image which may be used for speed estimation of moving objects. An imaging device 205 may not be calibrated when it is installed along the road network 210, rather, the imaging device 205 may be later calibrated.

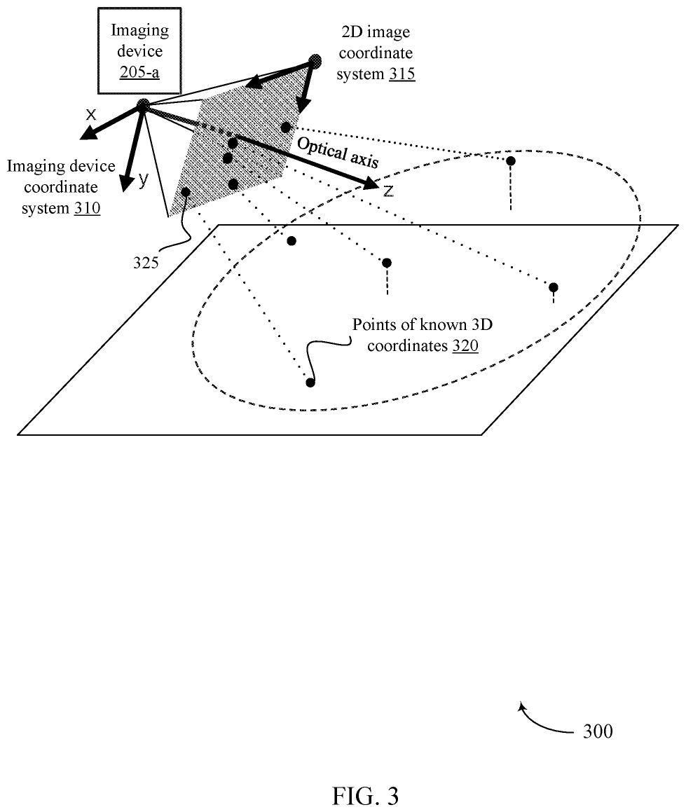

FIG. 3 illustrates an example of an imaging device calibration diagram 300 that supports communication-assisted automated camera calibration in accordance with one or more aspects of the present disclosure. In some examples, the imaging device calibration diagram 300 may include an imaging device 205-a, which may be an example of the imaging device 205, as described herein with reference to FIG. 2.

Imaging device calibration may identify a map between the world 3D coordinates of points in the FOV of the imaging device 205-a and the 2D coordinates of the projection of the points to the image captured by imaging device 205-a, via the lens. The mapping may be modeled as corresponding to a pinhole camera, where a 3D point projection to the image is a unique point of the intersection of a line connecting the 3D point to the imaging device center and the image or lens plane. The imaging device calibration diagram 300 shows the imaging device coordinate system 310 and the or 2D image coordinate system 315. Points 320 of known 3D coordinates in the FOV of the imaging device 205-a, such as landmarks or key points visible in the FOV, may be mapped to image points 325 of the image in the 2D image coordinate system 315. Calibration of the imaging device 205-a may include three steps: 1) identifying a quantity of correspondences, such as a set of pairs of known 3D coordinates and corresponding images coordinates, 2) forming a system of equations based on the identified correspondences, and 3) solving the system of equations to provide a mapping that may translate the 3D coordinates to the image coordinates and vice versa.

In some examples, two approaches may be available for identifying the correspondences for calibration of the imaging device 205-a. First, the correspondences may be manually or artificially introduced by placing objects of known dimensions or size and known position, such as known geographic coordinates, in the FOV of the imaging device 205-a. Alternatively, the correspondences for calibration may be based on known 3D coordinates of points or landmarks that exist in the FOV of the imaging device 205-a. For the imaging device 205-a that is already installed along the road network, the two approaches for identifying correspondences may be difficult to achieve. For example, introducing objects for imaging device calibration may be difficult if the imaging device 205-a is pointing to a busy intersection of the road network. Additionally, too few or no distinguishable or identifiable landmarks may be present in FOV of the imaging device 205-a. Even if landmarks exist in the FOV of the imaging device 205-a, a manual identification of the 3D coordinates or global positioning system (GPS) coordinates of the landmarks may be used which is a non-scalable solution to perform for thousands of imaging devices.

In some examples, vehicles on the road network in the FOV of the imaging device 205-a may be used as landmarks. A vehicle that appears in the image captured by the imaging device 205-a may determine a location of the vehicle, such as via GPS, and the vehicle may report the location or GPS coordinates to the imaging device 205-a that may be used as a correspondence for calibration. In some examples, the imaging device 205-a may collect a sufficient amount of correspondences using vehicles for calibration. Using vehicles as landmarks may be advantageous as it may be automated without manual measurements, however, this process may use an additional step of the imaging device 205-a associating vehicles reporting locations to vehicles present in the captured image.

In some examples, an offline automatic calibration of the imaging device 205-a may use the presence of vehicles in the image FOV without any knowledge of the (absolute) vehicle locations. Without knowledge of the vehicle absolute position, a relative calibration may be achieved, such as that the 3D position of points in the image are identified with respect to the imaging device 3D coordinate system. For example, the location of objects may be identified with respect to the location and heading (e.g., pointing direction) of the camera. If the imaging device world (e.g., absolute 3D) coordinates and heading are known, which may be the case for publicly available imaging devices, then an absolute calibration of the imaging device may be achieved by appropriate translation of the relative calibration. However, these offline calibration methods may not provide an accurate calibration due to uncertainties or errors in a-priori knowledge of relative coordinates of vehicles key points on which correspondences are created and uncertainties or errors in the knowledge of absolute camera position and/or heading.

Due to the uncertainties and errors, these offline calibration methods may not be suitable for applications that may require a high level of accuracy for the absolute positioning of objects (e.g., ADAS applications). The resulting calibration may be suitable for applications requiring information about the relative position and/or relative displacement of objects, such as speed estimation applications, and not absolute position of objects. Additionally, potential changes in imaging device orientation (e.g., due to weather) may result in a calibration mismatch. Accordingly, the calibration may be updated which may occur within a period of days or longer.

In some examples, when the imaging device 205-a has performed an offline calibration procedure, the imaging device 205-a may know an accuracy of the offline calibration. For example, the world coordinates of points in the image are known within some bounded uncertainty, such as within meters or possibly tens of meters. To refine the offline calibration, position information from vehicles within the FOV of the imaging device 205-a may be used to identify the correspondences used for calibration refinement. The association of position information from the vehicle to the vehicle position in the image may be established when the vehicles reporting position information are restricted to a bounded area, part of which is observable by the imaging device 205-a. For example, the imaging device 205-a may estimate that the vehicle within the FOV may be positioned within a finite area specified by absolute world coordinates. If a limited quantity of vehicles are located within the FOV at the same time and the vehicles each have unique visual characteristics or features that are detectable in the image, the associations for correspondences used in calibration refinement may be identified through the vehicles reporting visual characteristics and absolute positions.

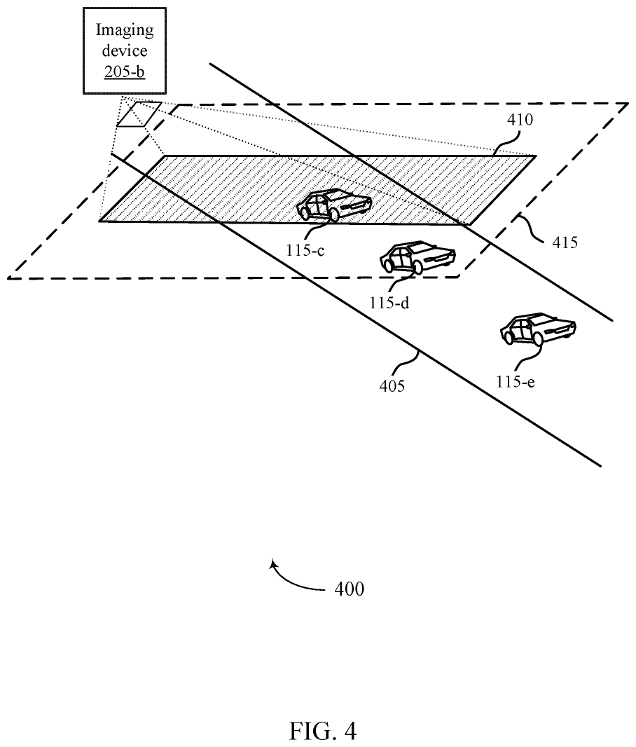

FIG. 4 illustrates an example of a diagram of a wireless communications system 400 that supports communication-assisted automated camera calibration in accordance with one or more aspects of the present disclosure. In some examples, the wireless communications system 400 may implement aspects of wireless communications system 100 and wireless communications system 200. The wireless communications system 400 may include an imaging device 205-b and UEs, such as a vehicle 115-c, a vehicle 115-d and a vehicle 115-e, which may be examples of corresponding imaging devices 205 and UEs 115, respectively, as described herein with reference to FIGS. 1 and 2. The UEs may be any type of UE, such as mobile UEs, vehicles, and UEs associated with pedestrians, bicycles, motorcycles and vehicles; for the following description, the UEs will be referred to as vehicles (e.g., vehicle 115-c, vehicle 115-d and vehicle 115-e).

In some examples, the imaging device 205-b may transmit a message requesting position reports from vehicles that satisfy a position condition. The imaging device 205-b may not know which vehicles, if any, satisfy the position condition. The vehicles (e.g., vehicle 115-c, vehicle 115-d and vehicle 115-e traveling along a road 405) may receive the message requesting position reports along with the position condition. If the vehicle determines that the position condition is satisfied, the vehicle may transmit, to the imaging device 205-b, a position report indicating a position of the vehicle and a visual characteristic of the vehicle.

In some examples, the position condition may be an indication of a geographic region, and the vehicle may satisfy the position condition by being located within the indicated geographic region. For the example shown in FIG. 4, the imaging device 205-b may request position reports from any vehicle that may be located within the geographic region 415. The geographic region 415 may coincide with an estimate of a 3D region corresponding to the FOV of the imaging device 205-b. Since the offline calibration of the imaging device 205-b may not be accurate, the estimate of the 3D region corresponding to the FOV may not be accurate. For the example illustrated in FIG. 4, the estimated 3D region corresponding to the FOV may be the geographic region 415 while the actual 3D region corresponding to the FOV of the imaging device 205-b may be the FOV region 410.

In some examples, the imaging device 205-b may transmit the message requesting the position reports from vehicles within a radius from the position of imaging device. For example, the imaging device 205-b may transmit the message via a sidelink groupcast option-1 transmission (e.g., the imaging device 205-b may be an example of a UE 115 as described herein). For this example, mobile UEs or vehicles within a communication range requirement field of a transmitted sidelink control information (SCI) format 2-A may report position information. In some examples, the positioning condition may be a defined geographic area. The imaging device 205-b may transmit an indication of the geographic area, and the vehicles may satisfy the positioning condition based on the vehicle determined position being located within the geographic area. For example, the geographic area may be the region 415, vehicle 115-c and vehicle 115-d may have positions located within the region 415, and the vehicle 115-c and the vehicle 115-d may transmit position reports to the imaging device 205-b

In some examples, the defined geographic area may be defined as a union of a set of areas corresponding to a set of zone identifiers. In some examples, the imaging device 205-b may transmit a sidelink broadcast transmission with the defined geographic area specified as part of the SCI (e.g., change of current SCI) or as part of the physical sidelink control channel (PSSCH) payload. In another example, the imaging device 205-b may transmit a downlink broadcast physical downlink control channel (PDCCH) transmission with the defined geographic area specified as part of payload (e.g., the imaging device 205-b may be a network entity 105 as described herein). In a further example, the imaging device 205-b may transmit a PDCCH transmission using a group-common downlink control information (DCI), such as a group previously established to correspond to vehicles with the area of interest.

In some examples for the position condition, the imaging device 205-b may transmit a reference signal to the vehicles, such as one or multiple CSI reference signals (CSI-RS) and/or synchronization signal blocks (SSB). For example, the CSI-RS and/or SSBs may be periodically transmitted using one or more beams that cover the geographic area of interest. Additionally, the imaging device 205-b may transmit an indication of an RSRP threshold value. The vehicle may satisfy the positioning condition based on an RSRP of the reference signal satisfying the RSRP threshold value.

In some examples, the imaging device 205-b may transmit an indication of a position, a heading, and the FOV of the imaging device 205-b. The FOV of the imaging device 205-b may be provided as a vertical and horizontal FOV in degrees. The vehicle 115-c may satisfy the positioning condition based on the vehicle determined location being within the FOV with respect to the position and heading of the imaging device 205-b. For example, if the vehicle 115-e is located behind the imaging device and impossible to appear in the captured image, the vehicle 115-e may not satisfy the positioning condition and may not transmit the position report. For the example wireless communications system 400 illustrated in FIG. 4, the vehicle 115-c is located within the FOV and may satisfy the positioning condition, vehicle 115-d and vehicle 115-e are not located within the FOV, and may not satisfy the positioning condition.

In some examples, the message requesting the position report may include an indication of a timing for determination of the position of the vehicle 115-c for inclusion within the position report. For example, the message requesting the position report may indicate a reference time-stamp. The time-stamp value may be based on a common clock among the imaging device 205-b and the vehicle 115-c, such as a global navigation satellite systems (GNSS) clock. In some examples, the reference time-stamp may be a future time. In some examples, the message requesting the position report may also include a time interval. The vehicle 115-c may transmit the position report including the position determined within the time interval prior to the time-stamp or within the time interval after the time-stamp. The vehicle 115-c may select the time corresponding to the vehicle determined position to include in the position report as long as the time is within limits provided by the time-stamp and the time interval. If no time interval is indicated in the message, the vehicle 115-c may report the position at a time corresponding to the reference time-stamp.

In some examples, the vehicle 115-c may transmit the position report to the imaging device 205-b. The position report may include the position of the vehicle 115-c, such as an absolute position of the vehicle 115-c. The position of the vehicle 115-c may be represented as geographic coordinates. In some examples, the position report may identify a vehicle point, such as center or front grill of the vehicle 115-c, corresponding to the reported geographic coordinates. In some examples, the position report may include a time-stamp indicating a time when the reported position coordinates were measured. In some examples, the position report may include an estimate of the reported absolute position accuracy, such as the absolute position may be within one meter of the reported position. In some examples, the position report may include a speed and/or a heading of the vehicle 115-c at the time of the position measurement. In some examples, the position report may include visual characteristics or features of the vehicle 115-c, such as the make and model, color, license plate number, and/or a vehicle type, such as sedan, truck or sport utility vehicle. In some examples, the position report may include the RSRP measurement value of the reference signal from the imaging device 205-b to provide an indication of a distance between the vehicle 115-c and the imaging device 205-b.

In some examples, the message requesting the position report may indicate the contents for the position report. For example, the message requesting the position report may include an indication to transmit, with the position report, the timestamp, the accuracy estimate, the speed of the vehicle 115-c, the heading of the vehicle 115-c, the make and model of the vehicle 115-c, the color of the vehicle 115-c, the vehicle type, the license plate number, and/or the RSRP measurement of the vehicle 115-c. In some examples, the contents of the position report may be indicated by pointers to a configured or pre-configured table, such as pointers to rows of a table. The table contents may be configured by the network via RRC messaging or may be predefined in specifications. In some examples, the vehicle 115-c may transmit the position report including the contents requested or a portion of available contents requested. In some examples, the message requesting the position report may indicate mandatory contents for the position report and optional contents for the position report; the vehicle 115-c may transmit the position report when the vehicle 115-c may provide at least the mandatory contents requested in the message. If the vehicle is unable to report the mandatory contents, the vehicle may not transmit the position report.

In some examples, the imaging device 205-b may receive multiple position reports from vehicles in the FOV region 410. For each position report, the imaging device 205-b may identify, in the image captured by imaging device 205-b at a time corresponding to the vehicle measured position in the position report, the vehicle 115-c corresponding to the vehicle 115-c transmitting the position repot based on the visual characteristic. The imaging device 205-b may determine an association or correspondence between the position of the vehicle 115-c and a portion of the image that includes the vehicle 115-c. The imaging device 205-b may perform this association process for each of the position reports received. Once the imaging device 205-b has determined associations between the vehicle positions identifying a quantity of correspondences, such as a set of pairs of 3D coordinates and corresponding images coordinates, the imaging device 205-b may perform the imaging device calibration procedure based using the associations.

In some examples, after the imaging device calibration or calibration refinement has been achieved, the imaging device 205-b may verify the calibration accuracy with an accuracy verification procedure. Due to possible changes in the position and/or heading of the imaging device 205-b, such as due to weather, the imaging device 205-b may periodically verify the calibration accuracy with the accuracy verification procedure.

In some examples, the imaging device 205-b may transmit a message to the vehicle 115-c to verify the accuracy of the position estimated with the refined calibration. The imaging device 205-b may transmit to the vehicle 115-c an indication of an estimated position of the vehicle in the 3D world as determined by the imaging device 205-b using the calibration. In some examples, if the vehicle's UE identification (ID) is known, the imaging device 205-b may transmit a unicast message via downlink or sidelink channel. If the vehicle's UE ID is not known, the imaging device 205-b may transmit a downlink or sidelink broadcast message with an indication of a visual characteristics of a vehicle identified in the FOV. The visual characteristic may be the make and model of the vehicle, the color of the vehicle, the license plate number of the vehicle, and/or a vehicle type. The message may also indicate a time-stamp corresponding to the time when the imaging device 205-b measured the position of the vehicle 115-c. The message may also indicate a position tolerance for evaluating the estimated position, such as if the actual vehicle position as measured by the vehicle 115-c should be within one meter from the provided estimated position.

In some examples, the vehicle 115-c may receive the message with the position estimated by the imaging device 205-b and a time stamp corresponding to the estimated position. The vehicle 115-c may identify whether the message is intended for the vehicle 115-c by verifying the visual characteristic(s). If so, the vehicle 115-c may determine whether the position estimated by the imaging device 205-b is within the position tolerance or threshold of the position determined by the vehicle 115-c at the time corresponding to the time-stamp. Based on the position accuracy of the position estimated by the imaging device 205-b, the vehicle 115-c may respond with an acknowledgment (ACK) or negative acknowledgment (NACK) feedback message. The vehicle 115-c may transmit, to the imaging device 205-b, the ACK message if the estimated position by the imaging device 205-b is within a threshold of a measured position of the vehicle 115-c performed by the vehicle 115-c at a time corresponding to the timestamp. In some examples, the vehicle 115-c may transmit, to the imaging device 205-b, a NACK message if the estimated position by the imaging device 205-b is outside of the threshold of the measured position of the vehicle 115-c performed by the vehicle 115-c at a time corresponding to the timestamp. In some examples, the vehicle 115-c may transmit, to the imaging device 205-b, a NACK message if the vehicle 115-c does not have a position measurement of the vehicle 115-c at a time corresponding to the timestamp. In some examples, the vehicle 115-c may refrain from transmitting a feedback message to the imaging device 205-b if the vehicle 115-c does not have a position measurement of the vehicle 115-c at a time corresponding to the timestamp. In some examples, a new type of HARQ codebook may be provided to indicate feedback of one of the above responses.

The imaging device 205-b may receive the feedback messages from the vehicle 115-c indicating whether the estimated position by the calibration is accurate. If the feedback indicates the calibration does not providing an accurate estimate of positioning within the threshold, the imaging device 205-b may repeat the calibration process.

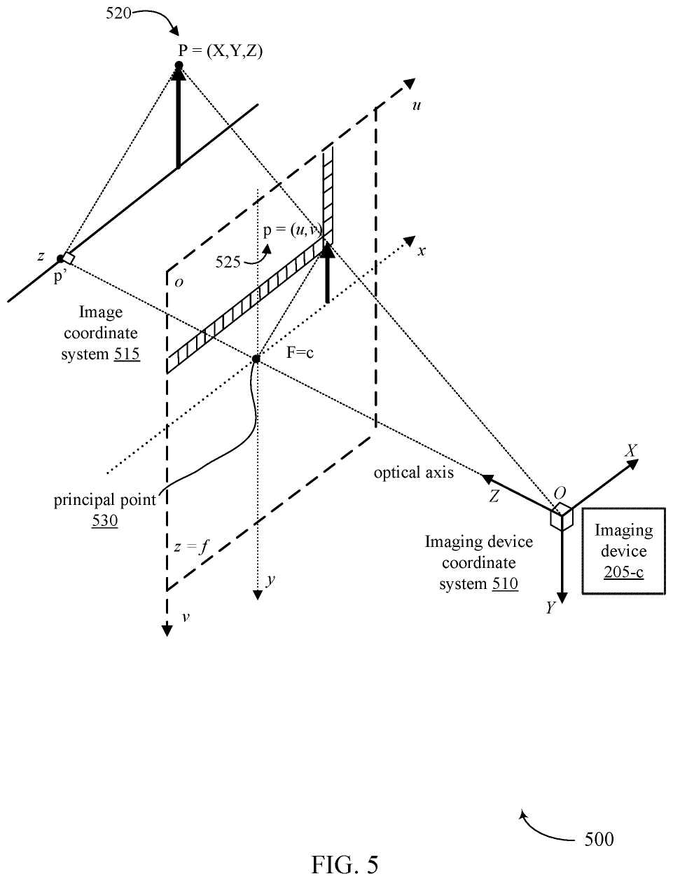

FIG. 5 illustrates an example of a imaging device calibration diagram 500 that supports communication-assisted automated camera calibration in accordance with one or more aspects of the present disclosure. In some examples, the imaging device calibration diagram 500 may include an imaging device 205-c, which may be an example of the imaging device 205, the imaging device 205-a and the imaging device 205-b, as described herein.

In some examples, imaging device calibration to calculate 3D coordinates from images coordinates may be illustrated with the diagram of FIG. 5. The imaging device calibration diagram 500 shows the imaging device coordinate system 510 and the pixel or image coordinate system 515. A point P 520 having 3D coordinates may be mapped to an image point p 525 of the image coordinate system 515 associated with the image of the imaging device 205-c. A principal point 530 may be located at the center of the image. For example, the imaging device calibration may be performed using equations with rotation vectors and translation vectors:

$$[ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ]$$

where (X, Y, Z) are the 3D coordinates of the point P 520 in the reference or world coordinate system, (u, v) are the coordinates (in pixels) of the projection point p 525 in the image coordinate system 515 of the image, (cₓ, c_{y}) is a principal point 530 typically (but not always) located at the image center, fₓ, f_{y} are focal lengths expressed in pixel units, s is a scaling factor, extrinsic parameters

$$[ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ]$$

correspond to a rotation (r) matrix and translation (t) vectors which translates coordinates of the 3D point to the imaging device coordinate system 510.

In some examples, an automated imaging device calibration technique may use known geographic fixtures, such as vehicle key points corresponding to left/right taillights, license plate, left/right side mirrors, rear brake lights, and head lights. The automated imaging device calibration technique may identify vehicles in a captured image using machine learning, may identify vehicle key points using machine learning through annotations of vehicle key points, may calibrate using known geometric fixtures corresponding to an identified vehicle model, and may filter the generated calibrations. The automated imaging device calibration technique may have theoretical limitations, such as that the output of automated imaging device calibration technique may not be in GPS coordinates as X-Y plane is an arbitrary choice, the road in the captured image may be assumed to be flat, the imaging device intrinsic parameter, such as focal length, may be assumed to be known and the vehicle's geometric properties, such as distance between taillights, may be assumed to be known.

In some examples, the automated imaging device calibration technique may have a set of all calibrations, such as rotation matrices and translation vectors obtained from calibration using each vehicle instance. An orientation filter may be applied where the orientation may be a third column of rotation matrix, and a deviation of each calibration's orientation may be computed from average orientations to keep p-value as minimal deviation calibrations. Focus points may be chosen by identifying a region of the image as the focus region, such as the road, and each calibration may map the focus point to the corresponding 3D point. A displacement filter may be computed by computing a distance between the imaging device and 3D coordinate of the focus point, and sorting calibrations by distance and picking middle q-values while discarding the remaining values. An orientation filter may be computed by computing deviation of each calibration's orientation from the average orientation while keeping minimal deviation calibrations. An average rotation may be computed as the average of the Z-axis unit vector across all filter calibrations and computing two mutually orthogonal X-axis and Y-axis unit vectors. A displacement may be computed using the average rotation matrix and recomputing the displacements for all filtered calibrations with the median value providing the translation vector for the calibration estimate. A calibration estimate may be determined as the averaged rotation matrix and translation vector.

The automated imaging device calibration technique may have some limitation as the output of the automated calibration system is not in global coordinates system, and the road is assumed to be flat and performance depends on vehicle key point detection and error therein. The automated imaging device calibration technique may be improved by the imaging device 205-c, such as a road-side unit (RSU) mounted camera, communicating with the vehicles.

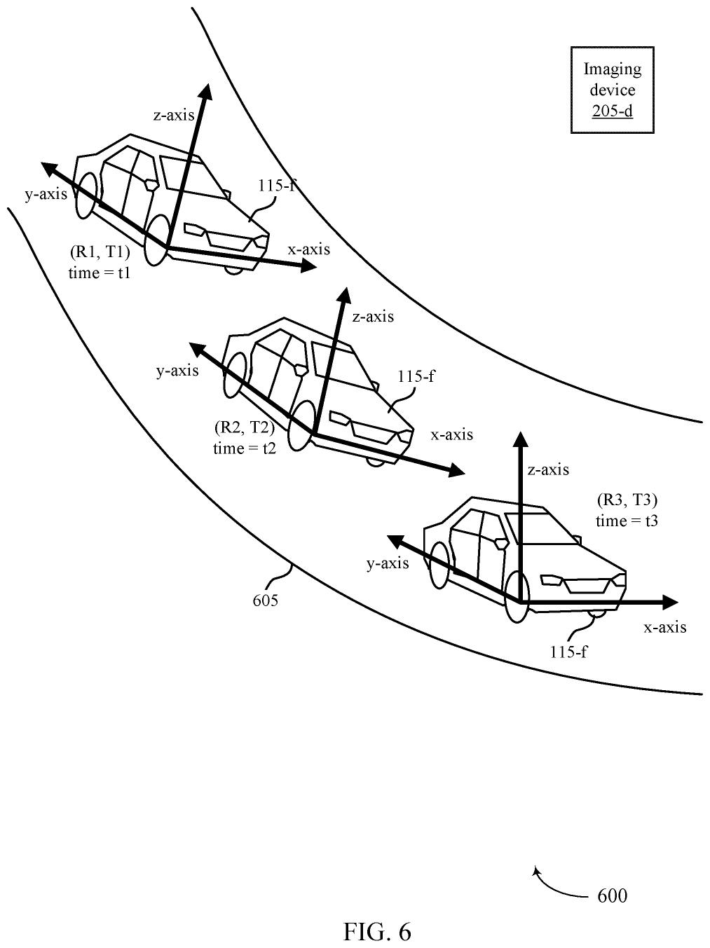

FIG. 6 illustrates an example of a wireless communications system 600 that supports communication-assisted automated camera calibration in accordance with one or more aspects of the present disclosure. In some examples, the wireless communications system 600 may implement aspects of the wireless communications system 100, the wireless communications system 200 and the wireless communications system 400. In some examples, the wireless communications system 600 may include an imaging device 205-d and a vehicle 115-f, which may be examples of corresponding imaging devices 205 and UEs 115, respectively, as described herein.

In some examples, the vehicle 115-f may be traveling along a road 605, and FIG. 6 illustrates the vehicle 115-f at different times (e.g., time t1, time t2, and time t3). The imaging device 205-d may transmit a message requesting the position report to the vehicle 115-f. In some examples, the imaging device 205-d may transmit an indication of a quantity of differential rotation matrices and differential translation vectors for the vehicle 115-f to report. In some examples, the vehicle 115-f may transmit a set of differential rotation matrices and differential translation vectors as contents of the position report. Each differential rotation matrix (R) may indicate a change in vehicle orientation between two respective times, and each differential translation vector (T) may indicate a change in vehicle position between the two respective times as the vehicle moves along the road. For the illustration of FIG. 6, the vehicle may be moving and the position and orientation of the vehicle 115-f may be shown at different times with corresponding (R, T), such as time t1 with (R1, T1), time t2 with (R2, T2) and time t3 with (R3, T3).

In some examples, the vehicle 115-f may transmit the position report including a vehicle identifier, such as a vehicle license plate or visual characteristic of the vehicle. For each pair of (R, T), a time-stamp corresponding to a previous time and a time-stamp corresponding to a current time instant for which the (R, T) pair is based may be indicated in the position report. For example, the position report may include (start time-stamp t1, end time-stamp t2, R_delta1, T_delta1), (start time-stamp t2, end time-stamp t3, R_delta2, T_delta2), and (start time-stamp t3, end time-stamp t4, R_delta3, T_delta3). In some examples, the time-stamps may be based on coordinated universal time (UTC) reference time that the imaging device 205-d and the vehicle 115-f may be aligned for time. In another example, the time-stamp may be based on a time reference provided by the imaging device 205-d or the vehicle 115-f. In some examples, the imaging device 205-d may transmit to the vehicle 115-f an indication of times at which to generate the set of differential rotation matrices and differential translation vectors, and the two respective times for each of the set of differential rotation matrices and differential translation vectors may be based on the indication of times.

In some examples, the accuracy of the automated imaging device calibration technique may be improved as the time differential rotation matrices and differential translation vectors provide additional constraints. Calibration may be possible for a non-flat road with varying normal vector over space as the rotation matrices and differential translation vectors provide an estimate of relative rotation of the normal vector for calibration based on the vehicle 115-f over time. In some examples, the vehicle 115-f may determine the relative rotation and translation over a short duration of time accurately even if the position determined by the vehicle 115-f may accumulate errors.

In some examples, the differential rotation matrix R1 may indicate a change in vehicle orientation between two respective times, and each differential translation vector T1 may indicate a change in vehicle position between the two respective times as the vehicle moves along the road. The R1 and T1 representing the vehicle orientation and position at time t1 may be obtained by identifying a set of correspondences between know 3D coordinates of vehicle key points, such as tail-lights or head-lights, and image coordinates of the vehicle key points. For each key point, a set of three equations for R1 and T1 at time t1 may be

$$s [ \begin{matrix}{u}_{{t}_{1}} \\ {v}_{{t}_{1}} \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ]$$

$$where R 1 is [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] , T 1 is [ \begin{matrix}{t}_{1} \\ {t}_{2} \\ {t}_{3}\end{matrix} ]$$

(X, Y, Z) are key point known world coordinates, (uₜ_{₁}, vₜ_{₁}) are the key point image coordinates and s is an unknown scaling factor. R1 and T1 may be determined by combining multiple sets of equations from multiple key points, such as at least four key points. A similar approach may be followed to determine (R2, T2) and (R3, T3) and so on.

In some examples, the pairs of (R, T) may be highly correlated, and the correlation may be exploited by utilizing all times to obtain more equations for the determination of (R1, T1) considering the differential information provided by the vehicle 115-f. For example, the resulting system of equations for each key point may be

$$s [ \begin{matrix}{u}_{{t}_{1}} \\ {v}_{{t}_{1}} \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ \begin{matrix}X \\ Y \\ Z \\ 1\end{matrix} ]$$

$$s [ \begin{matrix}{u}_{{t}_{2}} \\ {v}_{2} \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ {R}_{{\_ delta}_{1}} [ \begin{matrix}X \\ Y \\ Z\end{matrix} ] + {T}_{{\_ delta}_{1}} ]$$

$$s [ \begin{matrix}{u}_{{t}_{3}} \\ {v}_{{t}_{3}} \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3}\end{matrix} ] [ {R}_{{\_ delta}_{2}} {R}_{{\_ delta}_{1}} [ \begin{matrix}X \\ Y \\ Z\end{matrix} ] + {R}_{{\_ delta}_{2}} {T}_{{\_ delta}_{1}} + {T}_{{\_ delta}_{2}} ]$$

In some examples, the greater quantity of equations may allow (R1, T1) to be estimated more reliably in the presence of noisy measurements. Additionally, the greater quantity of equations may reduce the quantity of vehicle key points used for the computation. The equations may be extended to more than three instances.

In some examples, the timeline for messages between the imaging device 205-d and the vehicle 115-f may be as follows with respect to times t1, t2 and t3. Prior to t1, the imaging device 205-d may transmit a message with an indication to report a quantity of two differential rotation matrices and differential translation vectors. After time t1 and t2 and prior to time t3, the vehicle 115-f may transmit a first differential rotational matrix and first differential translation vector (start time-stamp t1, end time-stamp t2, R_delta1, T_delta1). After time t3, the vehicle may transmit a second differential rotational matrix and second differential translation vector (start time-stamp t2, end time-stamp t3, R_delta2, T_delta2).

In some examples, the message transmitted by the imaging device 205-d that triggers the vehicle measurements and reporting may indicate a strict schedule for the measurement times as a series of time stamps, such as t1, t2, t3 . . . , tN. Alternatively, the message may indicate a first time stamp and a last time stamp, such as two successive time stamps with a time spacing. In some examples, the vehicle 115-f may determine the quantity and timing of measurements in between the first time and the last time. In another example, the vehicle 115-f may determine the quantity of measurements, but the timing may be restricted to the time stamps provided by the imaging device 205-d. In a further examples, the timing of the measurements between the provided time stamps may be determined by the vehicle 115-f, but the quantity of measurements may be explicitly provided by the imaging device 205-d.

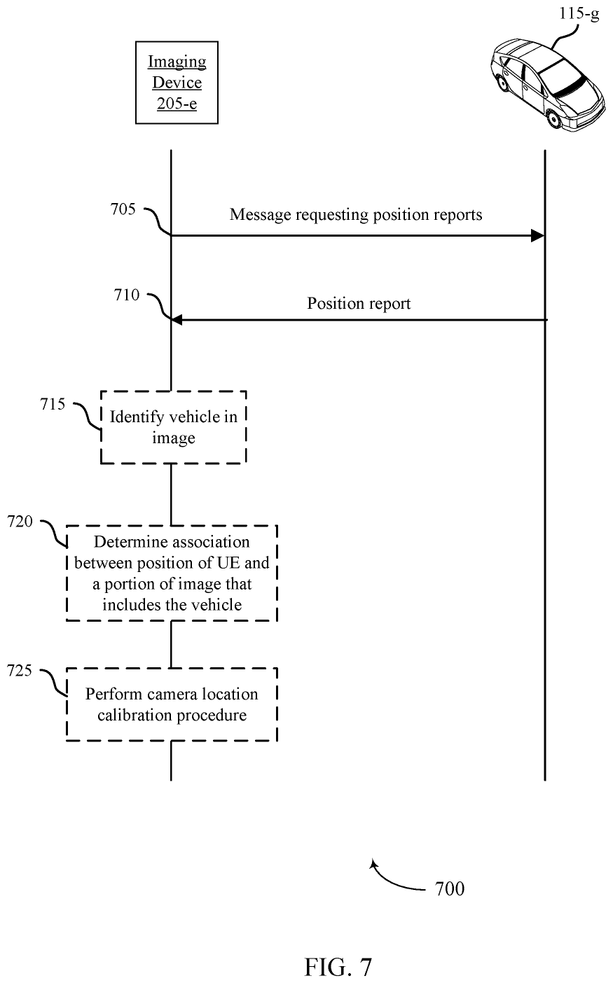

FIG. 7 illustrates an example of a process flow 700 that supports communication-assisted automated camera calibration in accordance with one or more aspects of the present disclosure. The process flow 700 may include an imaging device 205-e, which may be an example of the imaging devices 205 described herein. The process flow 700 may include a UE 115-g, such as a vehicle. which may be an example of UEs 115 described herein. In the following description of the process flow 700, the operations between the imaging device 205-e and the UE 115-g may be transmitted in a different order than the example order shown, or the operations performed by the imaging device 205-e and the UE 115-g may be performed in different orders or at different times. Some operations may also be omitted from the process flow 700, and other operations may be added to the process flow 700.

At 705, the imaging device 205-e may transmit a message requesting position reports from mobile UEs that satisfy a position condition. The UE 115-g may receive the message requesting position reports. At 710, the UE 115-g may transmit, to the imaging device 205-e and based on the UE 115-g satisfying the position condition, a position report indicating a position of the UE 115-g and a visual characteristic of the UE 115-g.

In some examples, the UE 115-g may receive an indication of a geographic region, and the UE 115-g may satisfy the positioning condition based on the UE 115-g being located within the geographic region. In some examples, the UE 115-g may receive a reference signal from the imaging device 205-e, and the UE 115-g may receive an indication of an RSRP threshold. The UE 115-g may satisfy the positioning condition based on an RSRP of the reference signal satisfying the RSRP threshold. In some examples, the UE 115-g may receive an indication of a position of the imaging device 205-e, a heading of the imaging device 205-e, and a FOV of the imaging device 205-e. The UE 115-g may satisfy the positioning condition based on the UE 115-g being located within the FOV of the imaging device 205-e with respect to the position of the imaging device 205-e and the heading of the imaging device 205-e.

In some examples, the message requesting position reports may include an indication to transmit, with the position report, the at least one of a timestamp, an accuracy estimate, a speed of the UE 115-g, a heading of the UE 115-g, a make and model of the UE 115-g, a color of the UE 115-g, a vehicle type, a license plate number, or an RSRP measurement. In some examples, the UE 115-g may receive an indication of a timing for determination of the position of the UE 115-g for inclusion within the position report.

In some examples, the position of the UE 115-g may include geographic coordinates of the UE 115-g. In some examples, the visual characteristic of the UE 115-g may include at the make and model of the UE 115-g, the color of the UE 115-g, the vehicle type of the UE 115-g, or the license plate number. In some examples, when the UE 115-g transmits the position report, the UE 115-g may transmit an indication of a timestamp indicating a time the position of the UE 115-g was measured, an accuracy estimate of the position, a speed of the UE 115-g, a heading of the UE 115-g, the make and model of the UE 115-g, a color of the UE 115-g, a vehicle type of the UE 115-g, a license plate number, and/or an RSRP measurement of the reference signal. In some examples, the UE 115-g may receive an indication of a timing for determination of the position of the UE 115-g for inclusion within the position report.

In some examples, for transmitting the position report, the UE 115-g may transmit a set of differential rotation matrices and differential translation vectors. Each differential rotation matrix may indicate a change in vehicle orientation between two respective times, and each differential translation vector may indicate a change in vehicle position between the two respective times. In some examples, for transmitting the position report, the UE 115-g may transmit an indication of the two respective times for each of the set of differential rotation matrices and differential translation vectors. In some examples, for receiving the message, the UE 115-g may receive an indication of times at which to generate the set of differential rotation matrices and differential translation vectors, and the two respective times for each of the set of differential rotation matrices and differential translation vectors may be based on the indication of times. In some examples, for receiving the message, the UE 115-g may receive an indication of a quantity of differential rotation matrices and differential translation vectors to report.

In some examples, at 715, the imaging device 205-e may identify, in an image captured by device at a time corresponding to the position report, a vehicle corresponding to the UE 115-g based on the visual characteristic. At 720, imaging device 205-e may determine an association between the position of the UE 115-g and a portion of the image that includes the vehicle. At 725, the imaging device 205-e may perform a camera location calibration procedure based on the association.

In some examples, the UE 115-g may receive, from the imaging device 205-e, a second message indicating an estimated position of the UE 115-g and a timestamp corresponding to the estimated position. The UE 115-g may transmit, to the imaging device 205-e, an ACK message in response to the second message based on the estimated position being within a threshold of a measured position of the UE 115-g as measured by the UE 115-g at a time corresponding to the timestamp. In some examples, the UE 115-g may transmit, to the imaging device 205-e, a NACK message in response to the second message based on the estimated position being outside of a threshold of a measured position of the UE 115-g as measured by the UE 115-g at a time corresponding to the timestamp. In some examples, the UE 115-g may transmit, to the imaging device 205-e, a NACK message in response to the second message based on the UE 115-g not having a position measurement of the UE 115-g at a time corresponding to the timestamp. In some examples, the UE 115-g may refrain from transmitting a feedback message to the imaging device based on the UE 115-g not having a position measurement of the UE 115-g at a time corresponding to the timestamp.

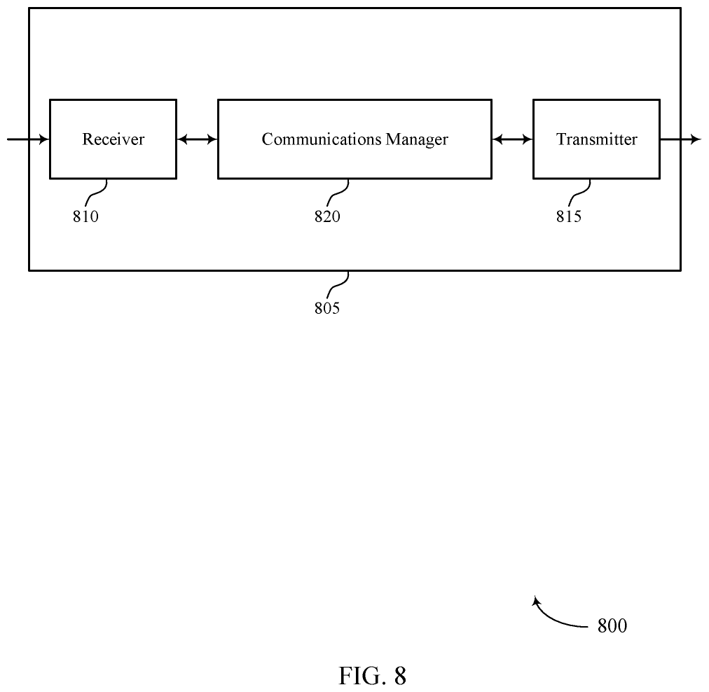

FIG. 8 illustrates a block diagram 800 of a device 805 that supports communication-assisted automated camera calibration in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to communication-assisted automated camera calibration). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to communication-assisted automated camera calibration). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of communication-assisted automated camera calibration as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. For example, the communications manager 820 may be configured as or otherwise support a means for receiving, from an imaging device, a message requesting position reports from mobile UEs that satisfy a positioning condition. The communications manager 820 may be configured as or otherwise support a means for transmitting, to the imaging device and based on the UE satisfying the positioning condition, a position report indicating a position of the UE and a visual characteristic of the UE.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for more efficient utilization of communication resources.

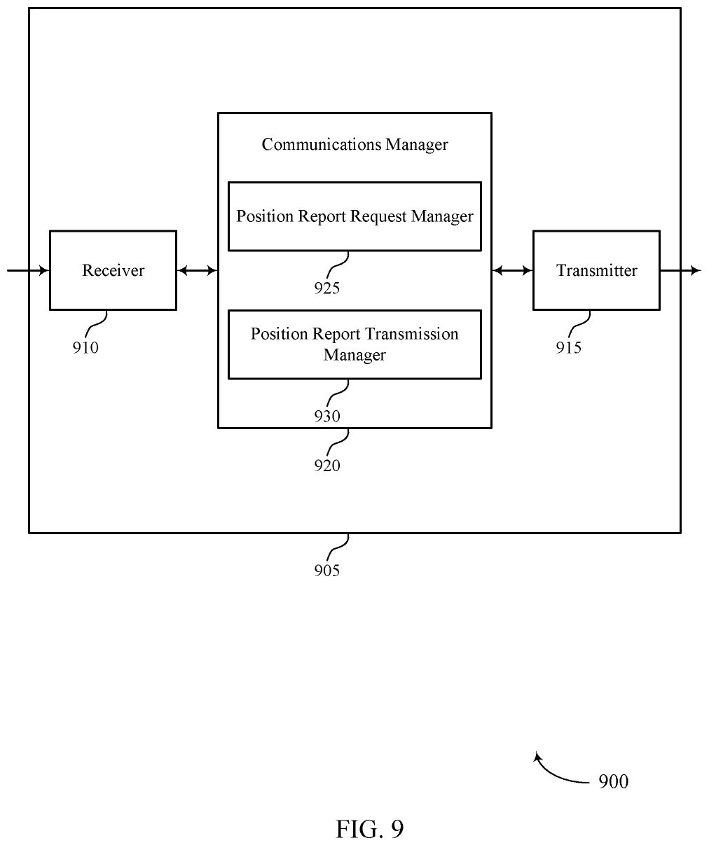

FIG. 9 illustrates a block diagram 900 of a device 905 that supports communication-assisted automated camera calibration in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to communication-assisted automated camera calibration). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to communication-assisted automated camera calibration). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of communication-assisted automated camera calibration as described herein. For example, the communications manager 920 may include a position report request manager 925 a position report transmission manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The position report request manager 925 may be configured as or otherwise support a means for receiving, from an imaging device, a message requesting position reports from mobile UEs that satisfy a positioning condition. The position report transmission manager 930 may be configured as or otherwise support a means for transmitting, to the imaging device and based on the UE satisfying the positioning condition, a position report indicating a position of the UE and a visual characteristic of the UE.

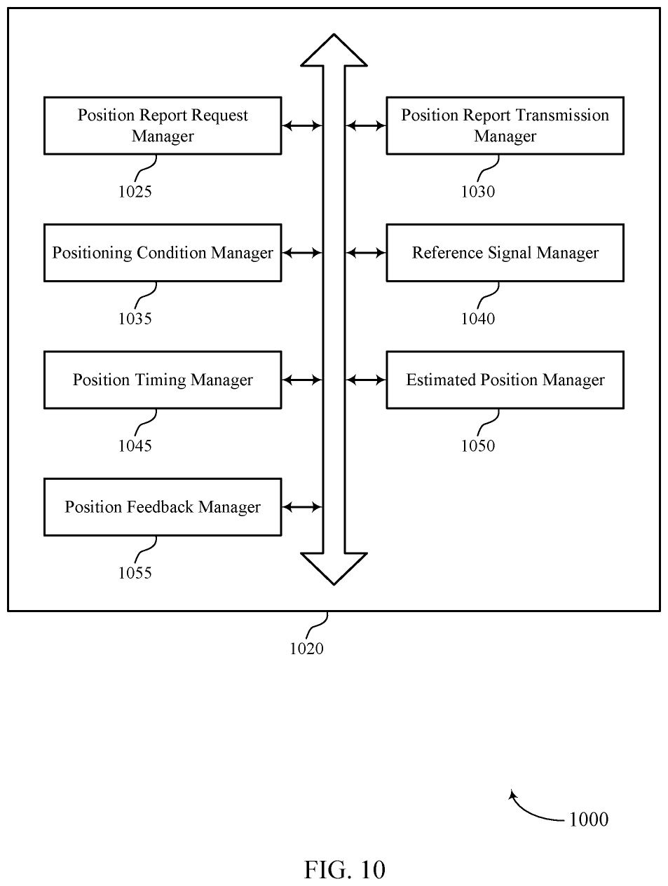

FIG. 10 illustrates a block diagram 1000 of a communications manager 1020 that supports communication-assisted automated camera calibration in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of communication-assisted automated camera calibration as described herein. For example, the communications manager 1020 may include a position report request manager 1025, a position report transmission manager 1030, a positioning condition manager 1035, a reference signal manager 1040, a position timing manager 1045, an estimated position manager 1050, a position feedback manager 1055, or any combination thereof. Each of these components may communicate, directly or indirectly, with one another (e.g., via one or more buses).

The communications manager 1020 may support wireless communications at a UE in accordance with examples as disclosed herein. The position report request manager 1025 may be configured as or otherwise support a means for receiving, from an imaging device, a message requesting position reports from mobile UEs that satisfy a positioning condition. The position report transmission manager 1030 may be configured as or otherwise support a means for transmitting, to the imaging device and based on the UE satisfying the positioning condition, a position report indicating a position of the UE and a visual characteristic of the UE.

In some examples, the positioning condition manager 1035 may be configured as or otherwise support a means for receiving an indication of a geographic region, where the UE satisfies the positioning condition based on the UE being located within the geographic region.

In some examples, the reference signal manager 1040 may be configured as or otherwise support a means for receiving a reference signal from the imaging device. In some examples, the positioning condition manager 1035 may be configured as or otherwise support a means for receiving an indication of an RSRP threshold, where the UE satisfies the positioning condition based on an RSRP of the reference signal satisfying the RSRP threshold.

In some examples, the positioning condition manager 1035 may be configured as or otherwise support a means for receiving an indication of a position of the imaging device, a heading of the imaging device, and a FOV of the imaging device, where the UE satisfies the positioning condition based on the UE being located within the FOV of the imaging device with respect to the position of the imaging device and the heading of the imaging device.

In some examples, the position timing manager 1045 may be configured as or otherwise support a means for receiving an indication of a timing for determination of the position of the UE for inclusion within the position report.

In some examples, the position includes geographic coordinates of the UE.

In some examples, to support transmitting the position report, the position report transmission manager 1030 may be configured as or otherwise support a means for transmitting an indication of at least one of a timestamp indicating a time the position of the UE was measured, an accuracy estimate of the position, a speed of the UE, a heading of the UE, a make and model of the UE, a color of the UE, a vehicle type of the UE, a license plate number, or an RSRP measurement responsive to the message.

In some examples, the visual characteristic includes at least one of the make and model of the UE, the color of the UE, the vehicle type of the UE, or the license plate number.

In some examples, to support receiving the message, the position report request manager 1025 may be configured as or otherwise support a means for receiving an indication to transmit, with the position report, the at least one of the timestamp, the accuracy estimate, the speed of the UE, the heading of the UE, the make and model of the UE, the color of the UE, the vehicle type, the license plate number, or the RSRP measurement.

In some examples, the estimated position manager 1050 may be configured as or otherwise support a means for receiving, from the imaging device, a second message indicating an estimated position of the UE and a timestamp corresponding to the estimated position. In some examples, the position feedback manager 1055 may be configured as or otherwise support a means for transmitting, to the imaging device, an ACK message in response to the second message based on the estimated position being within a threshold of a measured position of the UE performed by the UE at a time corresponding to the timestamp.

In some examples, the estimated position manager 1050 may be configured as or otherwise support a means for receiving a message indicating an estimated position of the UE and a timestamp corresponding to the estimated position. In some examples, the position feedback manager 1055 may be configured as or otherwise support a means for transmitting, to the imaging device, a NACK message in response to the second message based on the estimated position being outside of a threshold of a measured position of the UE performed by the UE at a time corresponding to the timestamp.

In some examples, the estimated position manager 1050 may be configured as or otherwise support a means for receiving a message indicating an estimated position of the UE and a timestamp corresponding to the estimated position. In some examples, the position feedback manager 1055 may be configured as or otherwise support a means for transmitting, to the imaging device, a NACK message in response to the second message based on the UE not having a position measurement of the UE performed by the UE at a time corresponding to the timestamp.

In some examples, the estimated position manager 1050 may be configured as or otherwise support a means for receiving a message indicating an estimated position of the UE and a timestamp corresponding to the estimated position. In some examples, the position feedback manager 1055 may be configured as or otherwise support a means for refraining from transmitting a feedback message to the imaging device in response to the second message based on the UE not having a position measurement of the UE performed by the UE at a time corresponding to the timestamp.

In some examples, to support transmitting the position report, the position report transmission manager 1030 may be configured as or otherwise support a means for transmitting a set of differential rotation matrices and differential translation vectors, each differential rotation matrix indicating a change in vehicle orientation between two respective times and each differential translation vector indicating a change in vehicle position between the two respective times.

In some examples, to support transmitting the position report, the position report transmission manager 1030 may be configured as or otherwise support a means for transmitting an indication of the two respective times for each of the set of differential rotation matrices and differential translation vectors.

In some examples, to support receiving the message, the position report request manager 1025 may be configured as or otherwise support a means for receiving an indication of times at which to generate the set of differential rotation matrices and differential translation vectors, where the two respective times for each of the set of differential rotation matrices and differential translation vectors are based on the indication of times.

In some examples, to support receiving the message, the position report request manager 1025 may be configured as or otherwise support a means for receiving an indication of a quantity of differential rotation matrices and differential translation vectors to report.

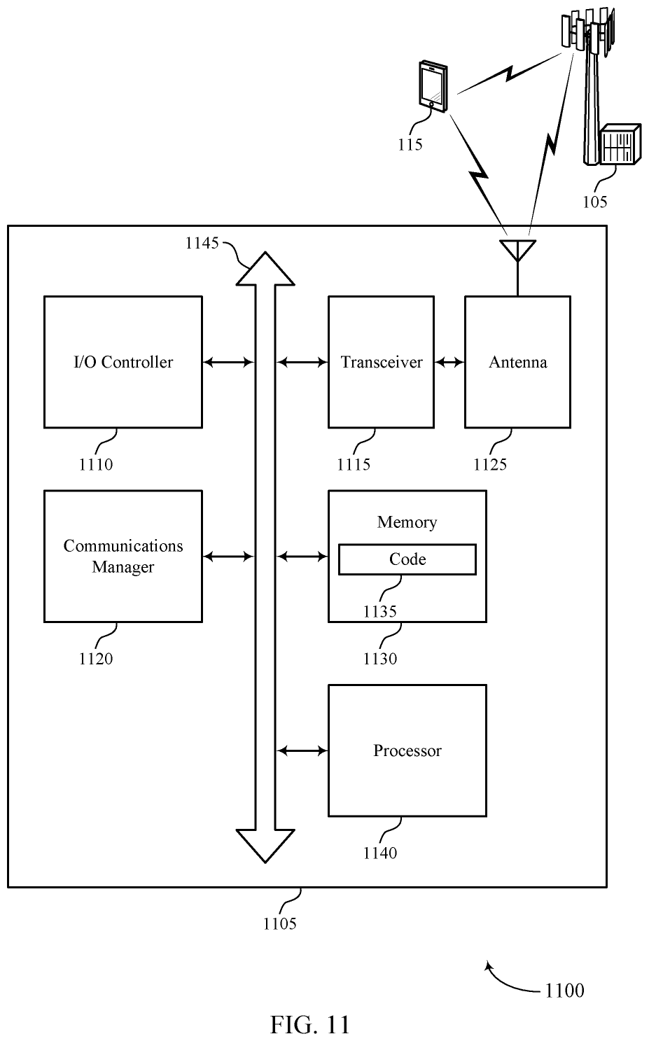

FIG. 11 illustrates a diagram of a system 1100 including a device 1105 that supports communication-assisted automated camera calibration in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting communication-assisted automated camera calibration). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a UE in accordance with examples as disclosed herein. For example, the communications manager 1120 may be configured as or otherwise support a means for receiving, from an imaging device, a message requesting position reports from mobile UEs that satisfy a positioning condition. The communications manager 1120 may be configured as or otherwise support a means for transmitting, to the imaging device and based on the UE satisfying the positioning condition, a position report indicating a position of the UE and a visual characteristic of the UE.

By including or configuring the communications manager 1120 in accordance with examples as described herein, the device 1105 may support techniques for improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of communication-assisted automated camera calibration as described herein, or the processor 1140 and the memory 1130 may be otherwise configured to perform or support such operations.

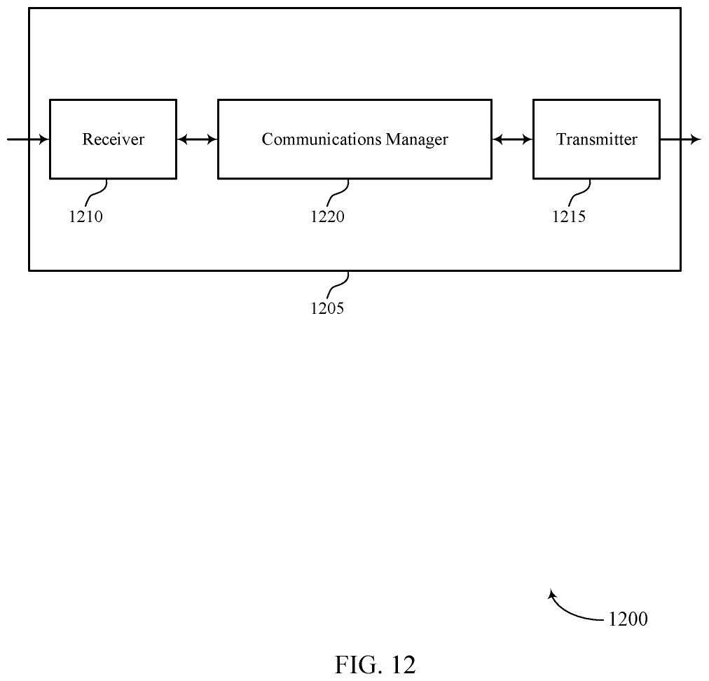

FIG. 12 illustrates a block diagram 1200 of a device 1205 that supports communication-assisted automated camera calibration in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of communication-assisted automated camera calibration as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at an imaging device in accordance with examples as disclosed herein. For example, the communications manager 1220 may be configured as or otherwise support a means for transmitting a message requesting position reports from mobile user equipments (UEs) that satisfy a positioning condition. The communications manager 1220 may be configured as or otherwise support a means for receiving, from a UE in response to the message, a position report indicating a position of the UE and a visual characteristic of the UE.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for more efficient utilization of communication resources.

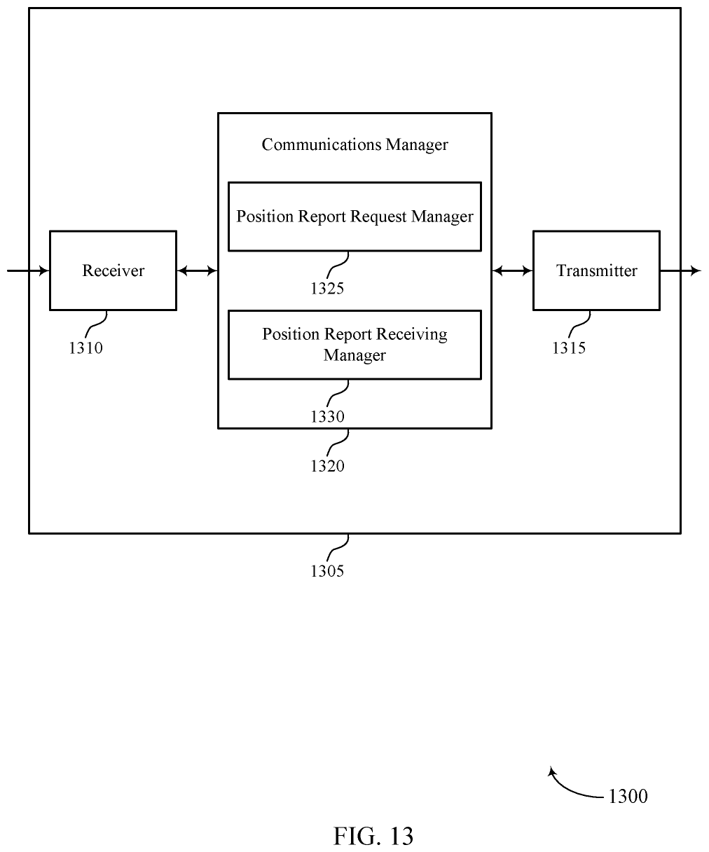

FIG. 13 illustrates a block diagram 1300 of a device 1305 that supports communication-assisted automated camera calibration in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of communication-assisted automated camera calibration as described herein. For example, the communications manager 1320 may include a position report request manager 1325 a position report receiving manager 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at an imaging device in accordance with examples as disclosed herein. The position report request manager 1325 may be configured as or otherwise support a means for transmitting a message requesting position reports from mobile user equipments (UEs) that satisfy a positioning condition. The position report receiving manager 1330 may be configured as or otherwise support a means for receiving, from a UE in response to the message, a position report indicating a position of the UE and a visual characteristic of the UE.

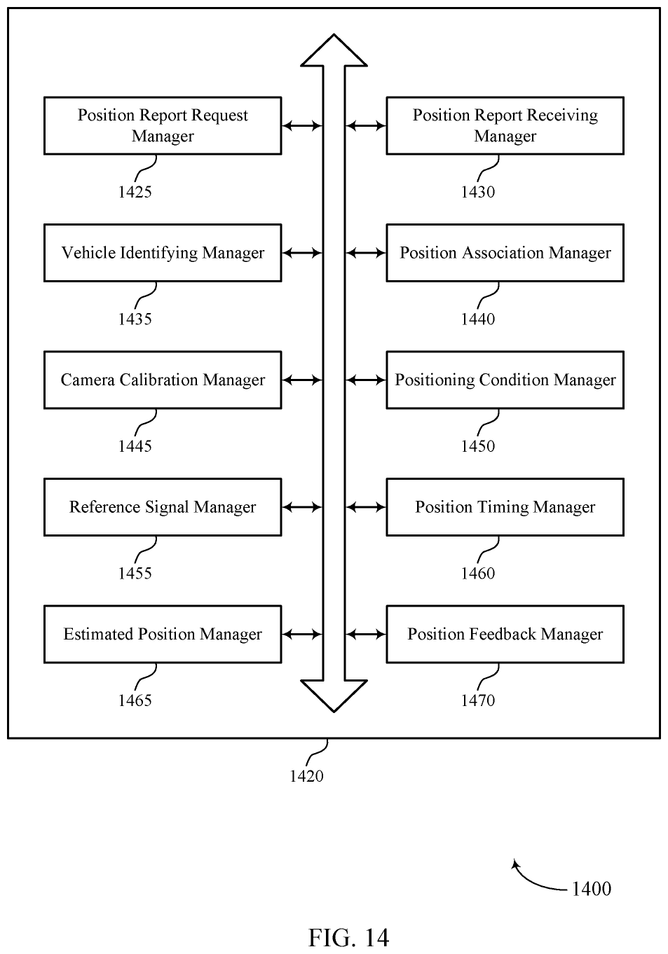

FIG. 14 illustrates a block diagram 1400 of a communications manager 1420 that supports communication-assisted automated camera calibration in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of communication-assisted automated camera calibration as described herein. For example, the communications manager 1420 may include a position report request manager 1425, a position report receiving manager 1430, a vehicle identifying manager 1435, a position association manager 1440, a camera calibration manager 1445, a positioning condition manager 1450, a reference signal manager 1455, a position timing manager 1460, an estimated position manager 1465, a position feedback manager 1470, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communications at an imaging device in accordance with examples as disclosed herein. The position report request manager 1425 may be configured as or otherwise support a means for transmitting a message requesting position reports from mobile user equipments (UEs) that satisfy a positioning condition. The position report receiving manager 1430 may be configured as or otherwise support a means for receiving, from a UE in response to the message, a position report indicating a position of the UE and a visual characteristic of the UE.

In some examples, the vehicle identifying manager 1435 may be configured as or otherwise support a means for identifying, in an image captured by the imaging device at a time corresponding to the position report, a vehicle corresponding to the UE based on the visual characteristic. In some examples, the position association manager 1440 may be configured as or otherwise support a means for determining an association between the position of the UE and a portion of the image that includes the vehicle. In some examples, the camera calibration manager 1445 may be configured as or otherwise support a means for performing a camera location calibration procedure based on the association.

In some examples, the positioning condition manager 1450 may be configured as or otherwise support a means for transmitting an indication of a geographic region, where the mobile UEs satisfy the positioning condition based on the mobile UEs being located within the geographic region.

In some examples, the reference signal manager 1455 may be configured as or otherwise support a means for transmitting a reference signal. In some examples, the positioning condition manager 1450 may be configured as or otherwise support a means for transmitting an indication of an RSRP threshold, where the mobile UEs satisfy the positioning condition based on an RSRP of the reference signal satisfying the RSRP threshold.

In some examples, the positioning condition manager 1450 may be configured as or otherwise support a means for transmitting an indication of a position of the imaging device, a heading of the imaging device, and a FOV of the imaging device, where the mobile UEs satisfy the positioning condition based on the mobile UEs being located within the FOV of the imaging device with respect to the position of the imaging device and the heading of the imaging device.

In some examples, the position timing manager 1460 may be configured as or otherwise support a means for transmitting an indication of a timing for determination of the position of the mobile UEs for inclusion within the position reports.

In some examples, the position includes geographic coordinates of the UE.

In some examples, to support receiving the position report, the position report receiving manager 1430 may be configured as or otherwise support a means for receiving an indication of at least one of a timestamp indicating a time the position of the UE was measured, an accuracy estimate of the position, a speed of the UE, a heading of the UE, a make and model of the UE, a color of the UE, a vehicle type of the UE, a license plate number, or an RSRP measurement responsive to the message.

In some examples, the visual characteristic includes at least one of the make and model of the UE, the color of the UE, the vehicle type of the UE, or the license plate number.

In some examples, to support transmitting the message, the position report request manager 1425 may be configured as or otherwise support a means for transmitting an indication to transmit, with the position reports, the at least one of the timestamp, the accuracy estimate, the speed of the UE, the heading of the UE, the make and model of the UE, the color of the UE, the vehicle type, the license plate number, or the RSRP measurement.

In some examples, the estimated position manager 1465 may be configured as or otherwise support a means for transmitting, to the UE in response to the position report, a second message indicating an estimated position of the UE and a timestamp corresponding to the estimated position. In some examples, the position feedback manager 1470 may be configured as or otherwise support a means for receiving, from the UE, an ACK message in response to the second message based on the estimated position being within a threshold of a measured position of the UE performed by the UE at a time corresponding to the timestamp.

In some examples, the estimated position manager 1465 may be configured as or otherwise support a means for transmitting, to the UE in response to the position report, a second message indicating an estimated position of the UE and a timestamp corresponding to the estimated position. In some examples, the position feedback manager 1470 may be configured as or otherwise support a means for receiving, from the UE, a NACK message in response to the second message based on the estimated position being outside of a threshold of a measured position of the UE performed by the UE at a time corresponding to the timestamp.

In some examples, the estimated position manager 1465 may be configured as or otherwise support a means for transmitting a second message indicating an estimated position of the UE and a timestamp corresponding to the estimated position. In some examples, the position feedback manager 1470 may be configured as or otherwise support a means for receiving, from the UE, NACK message in response to the second message based on the UE not having a position measurement of the UE performed by the UE at a time corresponding to the timestamp.

In some examples, to support receiving the position report, the position report receiving manager 1430 may be configured as or otherwise support a means for receiving a set of differential rotation matrices and differential translation vectors, each differential rotation matrix indicating a change in vehicle orientation between two respective times and each differential translation vector indicating a change in vehicle position between the two respective times.

In some examples, to support receiving the position report, the position report receiving manager 1430 may be configured as or otherwise support a means for receiving an indication of the two respective times for each of the set of differential rotation matrices and differential translation vectors.

In some examples, to support transmitting the message, the position report request manager 1425 may be configured as or otherwise support a means for transmitting an indication of times at which to generate the set of differential rotation matrices and differential translation vectors, where the two respective times for each of the set of differential rotation matrices and differential translation vectors are based on the indication of times.

In some examples, to support transmitting the message, the position report request manager 1425 may be configured as or otherwise support a means for an indication of a quantity of differential rotation matrices and differential translation vectors to report.

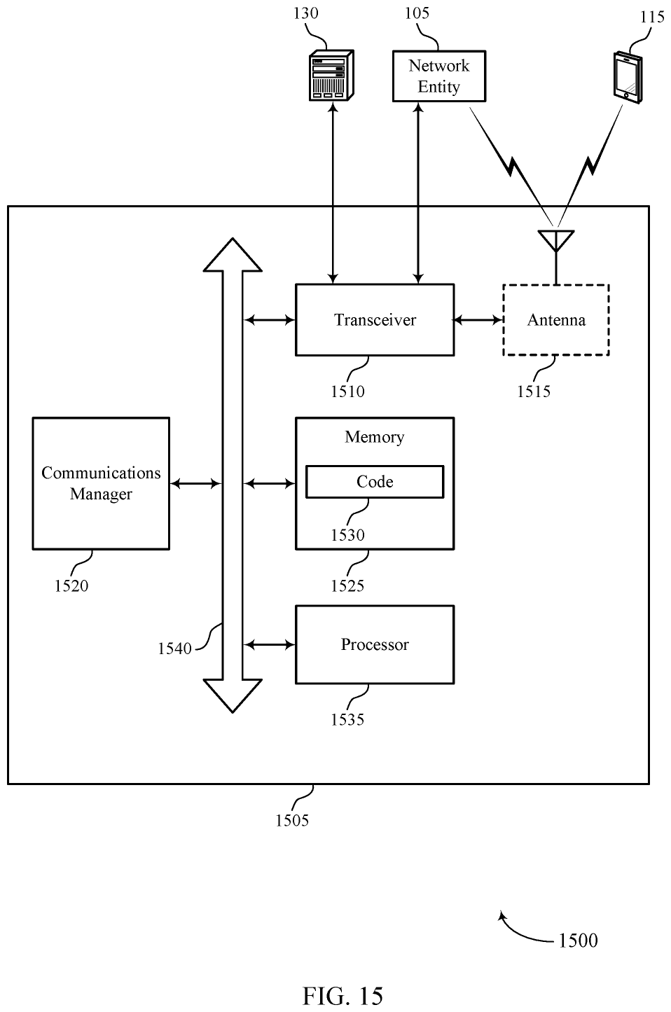

FIG. 15 illustrates a diagram of a system 1500 including a device 1505 that supports communication-assisted automated camera calibration in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting communication-assisted automated camera calibration). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communications at an imaging device in accordance with examples as disclosed herein. For example, the communications manager 1520 may be configured as or otherwise support a means for transmitting a message requesting position reports from mobile user equipments (UEs) that satisfy a positioning condition. The communications manager 1520 may be configured as or otherwise support a means for receiving, from a UE in response to the message, a position report indicating a position of the UE and a visual characteristic of the UE.

By including or configuring the communications manager 1520 in accordance with examples as described herein, the device 1505 may support techniques for improved coordination between devices.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of communication-assisted automated camera calibration as described herein, or the processor 1535 and the memory 1525 may be otherwise configured to perform or support such operations.

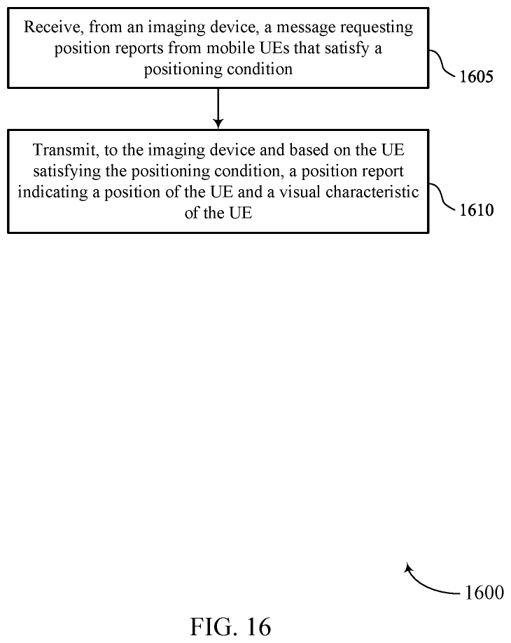

FIG. 16 illustrates a flowchart showing a method 1600 that supports communication-assisted automated camera calibration in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, from an imaging device, a message requesting position reports from mobile UEs that satisfy a positioning condition. The operations of 1605 may be performed in accordance with examples as disclosed herein. In some examples, aspects of the operations of 1605 may be performed by a position report request manager 1025 as described with reference to FIG. 10.

At 1610, the method may include transmitting, to the imaging device and based on the UE satisfying the positioning condition, a position report indicating a position of the UE and a visual characteristic of the UE. The operations of 1610 may be performed in accordance with examples as disclosed herein. In some examples, aspects of the operations of 1610 may be performed by a position report transmission manager 1030 as described with reference to FIG. 10.

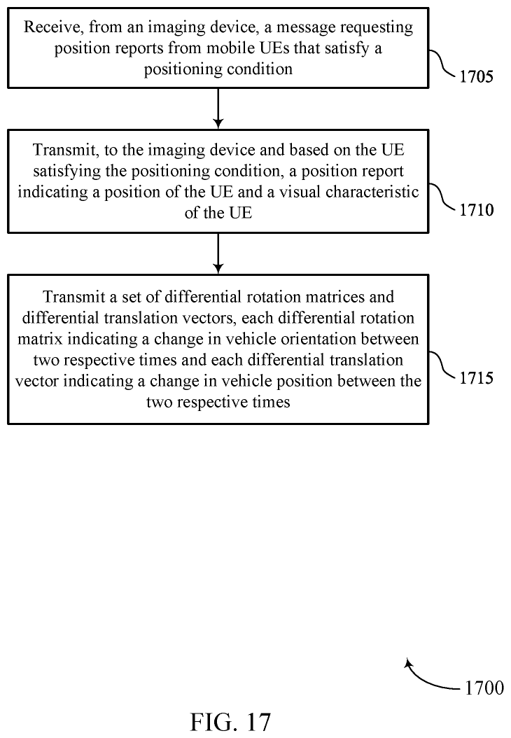

FIG. 17 illustrates a flowchart showing a method 1700 that supports communication-assisted automated camera calibration in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving, from an imaging device, a message requesting position reports from mobile UEs that satisfy a positioning condition. The operations of 1705 may be performed in accordance with examples as disclosed herein. In some examples, aspects of the operations of 1705 may be performed by a position report request manager 1025 as described with reference to FIG. 10.

At 1710, the method may include transmitting, to the imaging device and based on the UE satisfying the positioning condition, a position report indicating a position of the UE and a visual characteristic of the UE. The operations of 1710 may be performed in accordance with examples as disclosed herein. In some examples, aspects of the operations of 1710 may be performed by a position report transmission manager 1030 as described with reference to FIG. 10.

At 1715, the method may include transmitting a set of differential rotation matrices and differential translation vectors, each differential rotation matrix indicating a change in vehicle orientation between two respective times and each differential translation vector indicating a change in vehicle position between the two respective times. The operations of 1715 may be performed in accordance with examples as disclosed herein. In some examples, aspects of the operations of 1715 may be performed by a position report transmission manager 1030 as described with reference to FIG. 10.

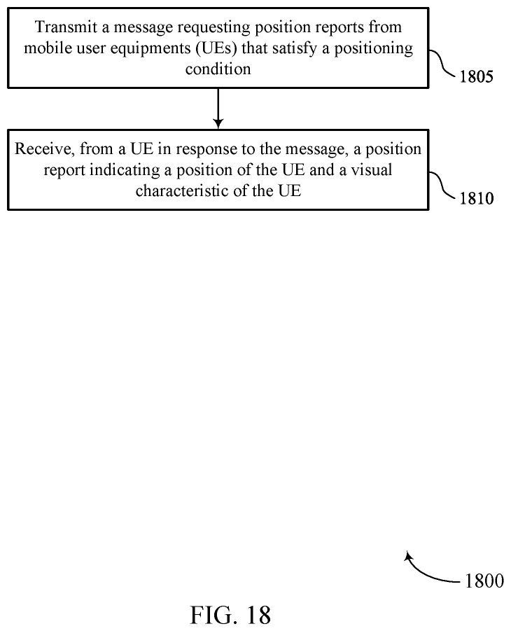

FIG. 18 illustrates a flowchart showing a method 1800 that supports communication-assisted automated camera calibration in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include transmitting a message requesting position reports from mobile user equipments (UEs) that satisfy a positioning condition. The operations of 1805 may be performed in accordance with examples as disclosed herein. In some examples, aspects of the operations of 1805 may be performed by a position report request manager 1425 as described with reference to FIG. 14.

At 1810, the method may include receiving, from a UE in response to the message, a position report indicating a position of the UE and a visual characteristic of the UE. The operations of 1810 may be performed in accordance with examples as disclosed herein. In some examples, aspects of the operations of 1810 may be performed by a position report receiving manager 1430 as described with reference to FIG. 14.

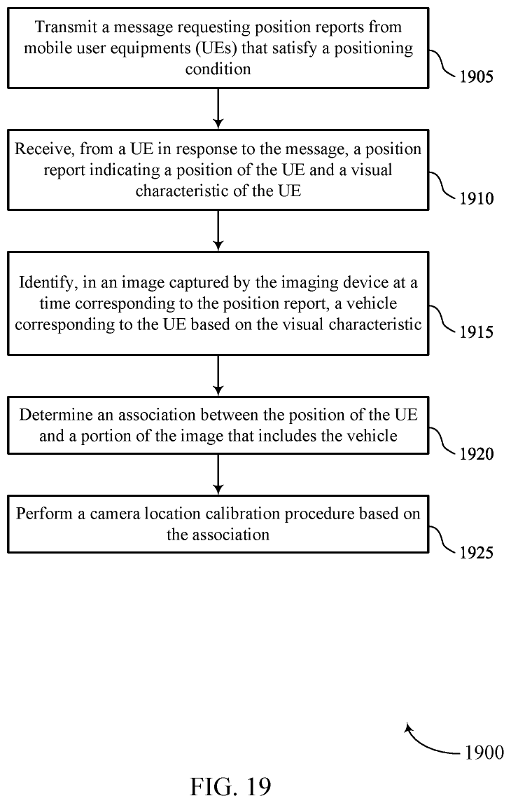

FIG. 19 illustrates a flowchart showing a method 1900 that supports communication-assisted automated camera calibration in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include transmitting a message requesting position reports from mobile user equipments (UEs) that satisfy a positioning condition. The operations of 1905 may be performed in accordance with examples as disclosed herein. In some examples, aspects of the operations of 1905 may be performed by a position report request manager 1425 as described with reference to FIG. 14.

At 1910, the method may include receiving, from a UE in response to the message, a position report indicating a position of the UE and a visual characteristic of the UE. The operations of 1910 may be performed in accordance with examples as disclosed herein. In some examples, aspects of the operations of 1910 may be performed by a position report receiving manager 1430 as described with reference to FIG. 14.

At 1915, the method may include identifying, in an image captured by the imaging device at a time corresponding to the position report, a vehicle corresponding to the UE based on the visual characteristic. The operations of 1915 may be performed in accordance with examples as disclosed herein. In some examples, aspects of the operations of 1915 may be performed by a vehicle identifying manager 1435 as described with reference to FIG. 14.

At 1920, the method may include determining an association between the position of the UE and a portion of the image that includes the vehicle. The operations of 1920 may be performed in accordance with examples as disclosed herein. In some examples, aspects of the operations of 1920 may be performed by a position association manager 1440 as described with reference to FIG. 14.

At 1925, the method may include performing a camera location calibration procedure based on the association. The operations of 1925 may be performed in accordance with examples as disclosed herein. In some examples, aspects of the operations of 1925 may be performed by a camera calibration manager 1445 as described with reference to FIG. 14.

The following provides an overview of aspects of the present disclosure:

Aspect 1: A method for wireless communications at a UE, comprising: receiving, from an imaging device, a message requesting position reports from mobile UEs that satisfy a positioning condition; and transmitting, to the imaging device and based on the UE satisfying the positioning condition, a position report indicating a position of the UE and a visual characteristic of the UE.

Aspect 2: The method of aspect 1, further comprising: receiving an indication of a geographic region, wherein the UE satisfies the positioning condition based on the UE being located within the geographic region.

Aspect 3: The method of aspect 1, further comprising: receiving a reference signal from the imaging device; and receiving an indication of a reference signal received power threshold, wherein the UE satisfies the positioning condition based on a reference signal received power of the reference signal satisfying the reference signal received power threshold.

Aspect 4: The method of aspect 1, further comprising: receiving an indication of a position of the imaging device, a heading of the imaging device, and a field of view of the imaging device, wherein the UE satisfies the positioning condition based on the UE being located within the field of view of the imaging device with respect to the position of the imaging device and the heading of the imaging device.

Aspect 5: The method of any of aspects 1 through 4, further comprising: receiving an indication of a timing for determination of the position of the UE for inclusion within the position report.

Aspect 6: The method of any of aspects 1 through 5, wherein the position comprises geographic coordinates of the UE.

Aspect 7: The method of any of aspects 1 through 6, wherein transmitting the position report comprises: transmitting an indication of at least one of a timestamp indicating a time the position of the UE was measured, an accuracy estimate of the position, a speed of the UE, a heading of the UE, a make and model of the UE, a color of the UE, a vehicle type of the UE, a license plate number, or a reference signal received power measurement responsive to the message.

Aspect 8: The method of any of aspects 1 through 7, wherein the visual characteristic comprises at least one of the make and model of the UE, the color of the UE, the vehicle type of the UE, or the license plate number.

Aspect 9: The method of aspect 7, wherein receiving the message comprises: receiving an indication to transmit, with the position report, the at least one of the timestamp, the accuracy estimate, the speed of the UE, the heading of the UE, the make and model of the UE, the color of the UE, the vehicle type, the license plate number, or the reference signal received power measurement.

Aspect 10: The method of any of aspects 1 through 9, further comprising: receiving, from the imaging device, a second message indicating an estimated position of the UE and a timestamp corresponding to the estimated position; and transmitting, to the imaging device, an ACK message in response to the second message based at least in part on the estimated position being within a threshold of a measured position of the UE performed by the UE at a time corresponding to the timestamp.

Aspect 11: The method of any of aspects 1 through 9, further comprising: receiving a message indicating an estimated position of the UE and a timestamp corresponding to the estimated position; and transmitting, to the imaging device, a NACK message in response to the second message based at least in part on the estimated position being outside of a threshold of a measured position of the UE performed by the UE at a time corresponding to the timestamp.

Aspect 12: The method of any of aspects 1 through 9, further comprising: receiving a message indicating an estimated position of the UE and a timestamp corresponding to the estimated position; and transmitting, to the imaging device, a NACK message in response to the second message based at least in part on the UE not having a position measurement of the UE performed by the UE at a time corresponding to the timestamp.

Aspect 13: The method of any of aspects 1 through 9, further comprising: receiving a message indicating an estimated position of the UE and a timestamp corresponding to the estimated position; and refraining from transmitting a feedback message to the imaging device in response to the second message based at least in part on the UE not having a position measurement of the UE performed by the UE at a time corresponding to the timestamp.

Aspect 14: The method of any of aspects 1 through 13, wherein transmitting the position report comprises: transmitting a set of differential rotation matrices and differential translation vectors, each differential rotation matrix indicating a change in vehicle orientation between two respective times and each differential translation vector indicating a change in vehicle position between the two respective times.

Aspect 15: The method of aspect 14, wherein transmitting the position report further comprises: transmitting an indication of the two respective times for each of the set of differential rotation matrices and differential translation vectors.

Aspect 16: The method of any of aspects 14 through 15, wherein receiving the message comprises: receiving an indication of times at which to generate the set of differential rotation matrices and differential translation vectors, wherein the two respective times for each of the set of differential rotation matrices and differential translation vectors are based at least in part on the indication of times.

Aspect 17: The method of any of aspects 14 through 16, wherein receiving the message comprises: receiving an indication of a quantity of differential rotation matrices and differential translation vectors to report.

Aspect 18: A method for wireless communications at an imaging device, comprising: transmitting a message requesting position reports from mobile user equipments (UEs) that satisfy a positioning condition; and receiving, from a UE in response to the message, a position report indicating a position of the UE and a visual characteristic of the UE.

Aspect 19: The method of aspect 18, further comprising: identifying, in an image captured by the imaging device at a time corresponding to the position report, a vehicle corresponding to the UE based at least in part on the visual characteristic; determining an association between the position of the UE and a portion of the image that includes the vehicle; and performing a camera location calibration procedure based at least in part on the association.

Aspect 20: The method of any of aspects 18 through 19, further comprising: transmitting an indication of a geographic region, wherein the mobile UEs satisfy the positioning condition based on the mobile UEs being located within the geographic region.

Aspect 21: The method of any of aspects 18 through 19, further comprising: transmitting a reference signal; and transmitting an indication of a reference signal received power threshold, wherein the mobile UEs satisfy the positioning condition based on a reference signal received power of the reference signal satisfying the reference signal received power threshold.

Aspect 22: The method of any of aspects 18 through 19, further comprising: transmitting an indication of a position of the imaging device, a heading of the imaging device, and a field of view of the imaging device, wherein the mobile UEs satisfy the positioning condition based on the mobile UEs being located within the field of view of the imaging device with respect to the position of the imaging device and the heading of the imaging device.

Aspect 23: The method of any of aspects 18 through 22, further comprising: transmitting an indication of a timing for determination of the position of the mobile UEs for inclusion within the position reports.

Aspect 24: The method of any of aspects 18 through 23, wherein the position comprises geographic coordinates of the UE.

Aspect 25: The method of any of aspects 18 through 24, wherein receiving the position report comprises: receiving an indication of at least one of a timestamp indicating a time the position of the UE was measured, an accuracy estimate of the position, a speed of the UE, a heading of the UE, a make and model of the UE, a color of the UE, a vehicle type of the UE, a license plate number, or a reference signal received power measurement responsive to the message.

Aspect 26: The method of any of aspects 18 through 25, wherein the visual characteristic comprises at least one of the make and model of the UE, the color of the UE, the vehicle type of the UE, or the license plate number.

Aspect 27: The method of aspect 25, wherein transmitting the message comprises: transmitting an indication to transmit, with the position reports, the at least one of the timestamp, the accuracy estimate, the speed of the UE, the heading of the UE, the make and model of the UE, the color of the UE, the vehicle type, the license plate number, or the reference signal received power measurement.

Aspect 28: The method of any of aspects 18 through 27, further comprising: transmitting, to the UE in response to the position report, a second message indicating an estimated position of the UE and a timestamp corresponding to the estimated position; and receiving, from the UE, an ACK message in response to the second message based at least in part on the estimated position being within a threshold of a measured position of the UE performed by the UE at a time corresponding to the timestamp.

Aspect 29: The method of any of aspects 18 through 27, further comprising: transmitting, to the UE in response to the position report, a second message indicating an estimated position of the UE and a timestamp corresponding to the estimated position; and receiving, from the UE, a NACK message in response to the second message based at least in part on the estimated position being outside of a threshold of a measured position of the UE performed by the UE at a time corresponding to the timestamp.

Aspect 30: The method of any of aspects 18 through 27 further comprising: transmitting a second message indicating an estimated position of the UE and a timestamp corresponding to the estimated position; and receiving, from the UE, a NACK message in response to the second message based at least in part on the UE not having a position measurement of the UE performed by the UE at a time corresponding to the timestamp.

Aspect 31: The method of any of aspects 18 through 30, wherein receiving the position report comprises: receiving a set of differential rotation matrices and differential translation vectors, each differential rotation matrix indicating a change in vehicle orientation between two respective times and each differential translation vector indicating a change in vehicle position between the two respective times.

Aspect 32: The method of aspect 31, wherein receiving the position report comprises: receiving an indication of the two respective times for each of the set of differential rotation matrices and differential translation vectors.

Aspect 33: The method of any of aspects 31 through 32, wherein transmitting the message comprises: transmitting an indication of times at which to generate the set of differential rotation matrices and differential translation vectors, wherein the two respective times for each of the set of differential rotation matrices and differential translation vectors are based at least in part on the indication of times.

Aspect 34: The method of any of aspects 31 through 33, wherein transmitting the message comprises: an indication of a quantity of differential rotation matrices and differential translation vectors to report.

Aspect 35: An apparatus for wireless communications at a UE, comprising a processor; memory coupled with the processor; and instructions stored in the memory and executable by the processor to cause the apparatus to perform a method of any of aspects 1 through 17.

Aspect 36: An apparatus for wireless communications at a UE, comprising at least one means for performing a method of any of aspects 1 through 17.

Aspect 37: A non-transitory computer-readable medium storing code for wireless communications at a UE, the code comprising instructions executable by a processor to perform a method of any of aspects 1 through 17.

Aspect 38: An apparatus for wireless communications at an imaging device, comprising a processor; memory coupled with the processor; and instructions stored in the memory and executable by the processor to cause the apparatus to perform a method of any of aspects 18 through 34.

Aspect 39: An apparatus for wireless communications at an imaging device, comprising at least one means for performing a method of any of aspects 18 through 34.

Aspect 40: A non-transitory computer-readable medium storing code for wireless communications at an imaging device, the code comprising instructions executable by a processor to perform a method of any of aspects 18 through 34.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor:
memory coupled with the processor; and
instructions stored in the memory’ and executable by the processor to cause the apparatus to:
receive, from an imaging device, a message requesting position reports from mobile UEs that satisfy a positioning condition; and
transmit, to the imaging device and based on the UE satisfying the positioning condition, a position report indicating a position of the UE and a visual characteristic of the UE.

2. The apparatus of claim 1, wherein the instructions are further executable by the processor to cause the apparatus to:
receive an indication of a geographic region, wherein the UE satisfies the positioning condition based on the UE being located within the geographic region.

3. The apparatus of claim 1, wherein the instructions are further executable by the processor to cause the apparatus to:
receive a reference signal from the imaging device; and
receive an indication of a reference signal received power threshold, wherein the UE satisfies the positioning condition based on a reference signal received power of the reference signal satisfying the reference signal received power threshold.

4. The apparatus of claim 1, wherein the instructions are further executable by the processor to cause the apparatus to:
receive an indication of a position of the imaging device, a heading of the imaging device, and a field of view of the imaging device, wherein the UE satisfies the positioning condition based on the UE being located within the field of view of the imaging device with respect to the position of the imaging device and the heading of the imaging device.

5. The apparatus of claim 1, wherein the instructions are further executable by the processor to cause the apparatus to:
receive an indication of a timing for determination of the position of the UE for inclusion within the position report.

6. The apparatus of claim 1, wherein the instructions to transmit the position report are executable by the processor to cause the apparatus to:
transmit an indication of at least one of a geographic coordinates of the UE, timestamp indicating a time the position of the UE was measured, an accuracy estimate of the position, a speed of the UE, a heading of the UE, a make and model of the UE, a color of the UE, a vehicle type of the UE, a license plate number, or a reference signal received power measurement responsive to the message.

7. (canceled)

8. The apparatus of claim 6, wherein the instructions to receive the message are executable by the processor to cause the apparatus to:
receive an indication to transmit, with the position report, the at least one of the timestamp, the accuracy estimate, the speed of the UE, the heading of the UE, the make and model of the UE, the color of the UE, the vehicle type, the license plate number, or the reference signal received power measurement.

9. The apparatus of claim 1, wherein the instructions are further executable by the processor to cause the apparatus to:
receive, from the imaging device, a second message indicating an estimated position of the UE and a timestamp corresponding to the estimated position; and
transmit, to the imaging device, an acknowledgment message in response to the second message based at least in part on the estimated position being within a threshold of a measured position of the UE performed by the UE at a time corresponding to the timestamp.

10. The apparatus of claim 1, wherein the instructions are further executable by the processor to cause the apparatus to:
receive a second message indicating an estimated position of the UE and a timestamp corresponding to the estimated position; and
transmit, to the imaging device, a negative acknowledgment message in response to the second message based at least in part on the estimated position being outside of a threshold of a measured position of the UE performed by the UE at a time corresponding to the timestamp.

11. The apparatus of claim 1, wherein the instructions are further executable by the processor to cause the apparatus to:
receive a second message indicating an estimated position of the UE and a timestamp corresponding to the estimated position; and
transmit, to the imaging device, a negative acknowledgment message in response to the second message based at least in part on the UE not having a position measurement of the UE performed by the UE at a time corresponding to the timestamp.

12. (canceled)

13. The apparatus of claim 1, wherein the instructions to transmit the position report are executable by the processor to cause the apparatus to:
transmit a set of differential rotation matrices and differential translation vectors, each differential rotation matrix indicating a change in vehicle orientation between two respective times and each differential translation vector indicating a change in vehicle position between the two respective times.

14. (canceled)

15. The apparatus of claim 13, wherein the instructions to receive the message are executable by the processor to cause the apparatus to:
receive an indication of times at which to generate the set of differential rotation matrices and differential translation vectors, wherein the two respective times for each of the set of differential rotation matrices and differential translation vectors are based at least in part on the indication of times.

16. (canceled)

17. An apparatus for wireless communications at an imaging device, comprising:
a processor:
memory coupled with the processor; and
instructions stored in the memory and executable by the processor to cause the apparatus to:
transmit a message requesting position reports from mobile user equipments (UEs) that satisfy a positioning condition; and
receive, from a UE in response to the message, a position report indicating a position of the UE and a visual characteristic of the UE.

18. The apparatus of claim 17, wherein the instructions are further executable by the processor to cause the apparatus to:
identify, in an image captured by the imaging device at a time corresponding to the position report, a vehicle corresponding to the UE based at least in part on the visual characteristic;
determine an association between the position of the UE and a portion of the image that includes the vehicle; and
perform a camera location calibration procedure based at least in part on the association.

19. The apparatus of claim 17, wherein the instructions are further executable by the processor to cause the apparatus to:
transmit an indication of a geographic region, wherein the mobile UEs satisfy the positioning condition based on the mobile UEs being located within the geographic region.

20. (canceled)

21. The apparatus of claim 17, wherein the instructions are further executable by the processor to cause the apparatus to:
transmit an indication of a position of the imaging device, a heading of the imaging device, and a field of view of the imaging device, wherein the mobile UEs satisfy the positioning condition based on the mobile UEs being located within the field of view of the imaging device with respect to the position of the imaging device and the heading of the imaging device.

22-24. (canceled)

25. The apparatus of claim 17, wherein the instructions are further executable by the processor to cause the apparatus to:
transmit, to the UE in response to the position report, a second message indicating an estimated position of the UE and a timestamp corresponding to the estimated position; and
receive, from the UE. an acknowledgment message in response to the second message based at least in part on the estimated position being within a threshold of a measured position of the UE performed by the UE at a time corresponding to the timestamp.

26. The apparatus of claim 17, wherein the instructions to receive the position report are executable by the processor to cause the apparatus to:
receive a set of differential rotation matrices and differential translation vectors, each differential rotation matrix indicating a change in vehicle orientation between two respective times and each differential translation vector indicating a change in vehicle position between the two respective times.

27-28. (canceled)

29. A method for wireless communications at an imaging device, comprising:
transmitting a message requesting position reports from mobile user equipments (UEs) that satisfy a positioning condition; and
receiving, from a UE in response to the message, a position report indicating a position of the UE and a visual characteristic of the UE.

30. The method of claim 29, further comprising:
identifying, in an image captured by the imaging device at a time corresponding to the position report, a vehicle corresponding to the UE based at least in part on the visual characteristic;
determining an association between the position of the UE and a portion of the image that includes the vehicle; and
performing a camera location calibration procedure based at least in part on the association.
